(19) United States
(12) Patent Application Publication
(10) Pub. No.: US 2025/0097815 A1
(43) Pub. Date: Mar. 20, 2025

(54) ELECTRONIC DEVICE, USER EQUIPMENT, WIRELESS COMMUNICATION METHOD, AND STORAGE MEDIUM

(71) Applicant: Sony Group Corporation, Tokyo (JP)

(72) Inventors: Mingtuo ZHOU, Shanghai (CN); Min LIU, Beijing (CN)

(73) Assignee: Sony Group Corporation, Tokyo (JP)

(21) Appl. No.: 18/294,195

(22) PCT Filed: Aug. 3, 2022
(86) PCT No.: PCT/CN2022/109820

§ 371 Date: Feb. 1, 2024

(30) Foreign Application Priority Data
Aug. 10, 2021 (CN) 202110913959.4

(51) Int. Cl. H04W 40/04; H04W 52/02; H04W 84/06

(52) U.S. Cl. CPC H04W 40/04; H04W 52/0261; H04W 84/06

(57) ABSTRACT

An electronic device includes a processing circuit, and is configured to: determine one or more candidate relay devices of a user equipment; sort the one or more candidate relay devices according to energy collection capability of the one or more candidate relay devices so as to generate an ordered set of the candidate relay devices; and send the ordered set of the candidate relay devices to the user equipment, such that the user equipment determines a relay device according to the ordered set of the candidate relay devices and communicates with a satellite device by using the relay device, wherein each candidate relay device converts the collected energy into electric energy to supply power to the candidate relay device.

The present application claims priority to Chinese Patent Application No. 202110913959.4, titled “ELECTRONIC DEVICE, USER EQUIPMENT, WIRELESS COMMUNICATION METHOD, AND STORAGE MEDIUM”, filed on Aug. 10, 2021 with the China National Intellectual Property Administration, which is incorporated herein by reference in its entirety.

### FIELD

Embodiments of the present disclosure generally relate to the field of wireless communications, and in particular to an electronic device, user equipment, a wireless communication method, and a storage medium. More particularly, the present disclosure relates to an electronic device as a network side device in a wireless communication system, user equipment in a wireless communication system, a wireless communication method performed by a network side device in a wireless communication system, a wireless communication method performed by user equipment in a wireless communication system, and a computer readable storage medium.

### BACKGROUND

In a non-terrestrial network (NTN), many user equipment generates relatively small and not particularly urgent data packets, and thus can tolerate a relatively large delay. Every time the user equipment generates data, the user equipment immediately transmits the data to a satellite device, which consumes a lot of signaling resources and energy. In addition, in a case that multiple user equipment located at close positions transmits data simultaneously, the multiple user equipment may interfere with each other, thereby affecting the quality of transmission.

On the other hand, in the Internet of Things without power supply, the user equipment may supply power through energy harvesting. In such a network, available electrical energy to each user equipment dynamically changes with an energy harvesting capability and an energy source condition of the user equipment.

Therefore, it is required to provide a technical solution to reduce the signaling overhead in an NTN including user equipment that supplies power through energy harvesting, and saves energy for the user equipment.

### SUMMARY

A summary of the present disclosure is provided in this section, which is not a comprehensive disclosure of the full scope or all features of the present disclosure.

An object of the present disclosure is to provide an electronic device, user equipment, a wireless communication method, and a storage medium, to reduce the signaling overhead in an NTN including user equipment that supplies power through energy harvesting, and save energy for the user equipment.

According to an aspect of the present disclosure, an electronic device is provided. The electronic device includes processing circuitry configured to determine one or more candidate relay devices for user equipment; rank the one or more candidate relay devices based on energy harvesting capabilities of the one or more candidate relay devices to generate an ordered set of candidate relay devices; and send the ordered set of candidate relay devices to the user equipment, for the user equipment to determine a relay device based on the ordered set of candidate relay devices and to communicate with a satellite device using the relay device. The candidate relay device converts harvested energy into electrical energy to supply power to the candidate relay device.

According to another aspect of the present disclosure, user equipment is provided. The user equipment includes processing circuitry configured to: receive an ordered set of candidate relay devices from a network side device, where the ordered set of candidate relay devices is generated by ranking one or more candidate relay devices based on energy harvesting capabilities of the one or more candidate relay devices; sequentially perform connection with candidate relay devices in the ordered set of candidate relay devices according to an order in the ordered set of candidate relay devices until successful connection with a candidate relay device, and determine the candidate relay device in successful connection as a relay device; and communicate with a satellite device using the relay device. The candidate relay device converts harvested energy into electrical energy to supply power to the candidate relay device.

According to another aspect of the present disclosure, a wireless communication method performed by an electronic device is provided. The method includes: determining one or more candidate relay devices for user equipment; ranking the one or more candidate relay devices based on energy harvesting capabilities of the one or more candidate relay devices to generate an ordered set of candidate relay devices; and sending the ordered set of candidate relay devices to the user equipment, for the user equipment to determine a relay device according to the ordered set of candidate relay devices and to communicate with a satellite device using the relay device. The candidate relay device converts harvested energy into electrical energy to supply power to the candidate relay device.

According to another aspect of the present disclosure, a wireless communication method performed by user equipment is provided. The method includes: receiving an ordered set of candidate relay devices from a network side device, where the ordered set of candidate relay devices is generated by ranking one or more candidate relay devices based on energy harvesting capabilities of the one or more candidate relay devices; sequentially performing connection with candidate relay devices in the ordered set of candidate relay devices according to an order in the ordered set of candidate relay devices until successful connection with a candidate relay device, and determining the candidate relay device in successful connection as a relay device; and communicating with a satellite device using the relay device. The candidate relay device converts harvested energy into electrical energy to supply power to the candidate relay device.

According to another aspect of the present disclosure, a computer readable storage medium is provided. The computer readable storage medium includes executable computer instructions that, when executed by a computer, cause the computer to perform the wireless communication method according to the present disclosure.

According to another aspect of the present disclosure, a computer program is provided. The computer program, when executed by a computer, causes the computer to perform the wireless communication method according to the present disclosure.

With the electronic device, the user equipment, the wireless communication method, and the computer readable storage medium according to the present disclosure, the electronic device can rank the candidate relay devices based on energy harvesting capabilities, for the user equipment to determine the relay device and to communicate with the satellite device using the relay device. In this way, the user equipment can communicate with the satellite device using the relay device, so as to reduce energy consumption of the user equipment. In addition, the relay device is required to forward data for multiple user equipment, which requires a lot of energy. Since the relay device is determined based on energy harvesting capabilities, it can be ensured that the determined relay device has a good energy harvesting capability.

Further areas of capability will become apparent from the description provided herein. The description and specific examples in the summary are only illustrative and are not intended to limit the scope of the present disclosure.

### BRIEF DESCRIPTION OF THE DRAWINGS

The drawings described herein are for illustrating selected embodiments only rather than all possible implementations, and are not intended to limit the scope of the present disclosure. In the drawings:

FIG. 1 is a schematic diagram showing an application scenario according to an embodiment of the present disclosure;

FIG. 2 is a graph showing a change in energy of user equipment over time according to an embodiment of the present disclosure;

FIG. 3 is a block diagram showing an example of configuration of an electronic device as a network side device according to an embodiment of the present disclosure;

FIG. 4 is a schematic diagram showing a scenario where user equipment communicates with a satellite device utilizing a relay device according to an embodiment of the present disclosure;

FIG. 5 is a schematic diagram showing an energy change curve according to an embodiment of the present disclosure;

FIG. 6 is a schematic diagram showing a process of determining a candidate relay device based on a transmission power according to an embodiment of the present disclosure;

FIG. 7 is a flowchart showing signaling for a process of determining a relay device for user equipment according to an embodiment of the present disclosure;

FIG. 8 is a schematic diagram showing an updating time period and a transmission time period of a relay device according to an embodiment of the present disclosure;

FIG. 9 is a flowchart showing signaling for a process of updating a user equipment group and a relay device according to an embodiment of the present disclosure;

FIG. 10 is a block diagram showing an example of configuration of user equipment according to an embodiment of the present disclosure;

FIG. 11 is a flowchart of a wireless communication method performed by an electronic device as a network side device according to an embodiment of the present disclosure;

FIG. 12 is a flowchart of a wireless communication method performed by user equipment according to an embodiment of the present disclosure;

FIG. 13 is a block diagram showing a first example of a schematic configuration of an Evolved Node B (eNB);

FIG. 14 is a block diagram showing a second example of a schematic configuration of an eNB;

FIG. 15 is a block diagram showing an example of a schematic configuration of a smartphone; and

FIG. 16 is a block diagram showing an example of a schematic configuration of a car navigation device.

Although various modifications and alternations are easily made to the present disclosure, specific embodiments of the present disclosure are shown in the drawings by examples, and are described in detail herein. It should be understood that description for the specific embodiments herein is not intended to limit the present disclosure to the specific form as disclosed. Instead, the present disclosure aims to cover all modifications, equivalents and alternations within the spirit and scope of the present disclosure. It is noted that throughout the drawings, corresponding reference numerals indicate corresponding parts.

### DETAILED DESCRIPTION OF EMBODIMENTS

Examples of the present disclosure are fully disclosed with reference to the drawings. The following description is merely illustrative and is not intended to limit the present disclosure and applications or usage thereof.

Exemplary embodiments are provided so that the present disclosure becomes thorough and the scope thereof is fully conveyed to those skilled in the art. Numerous specific details such as examples of specific components, devices and methods are set forth to provide a thorough understanding of embodiments of the present disclosure. It is apparent for those skilled in the art that, exemplary embodiments may be implemented in various ways without these specific details, which should not be constructed as limiting the scope of the present disclosure. In some exemplary embodiments, well-known processes, structures and technologies are not described in detail.

Description is made in the following order:
1. Description of a scenario;
2. Configuration example of a network side device;
3. Configuration example of user equipment;
4. Method embodiments; and
5. Application example.

### 1. Description of a Scenario

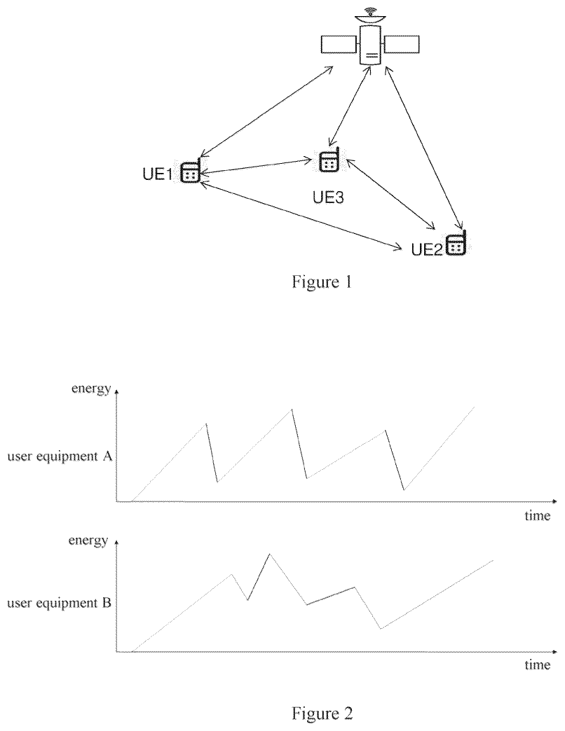

FIG. 1 is a schematic diagram showing an application scenario according to an embodiment of the present disclosure. As shown in FIG. 1, a wireless communication system may include a satellite device and multiple user equipment. The user equipment may directly communicate with the satellite device, and D2D communication may also be performed between the user equipment.

According to the embodiments of the present disclosure, in the wireless communication system, each user equipment may harvest energy, and convert the harvested energy into electrical energy to supply power to the user equipment. The energy may include all of energy that can be converted into electrical energy, such as solar energy, wind energy, tidal energy, and geothermal energy.

According to the embodiments of the present disclosure, the speed of energy harvesting varies among various user equipment due to differences in energy harvesting capability, position, energy source, weather condition associated with the energy source, and antenna parameter of the various user equipment. In addition, the speed of energy consumption varies among various user equipment due to differences in the size of data packets, the transmission rate of the data packets, the time interval between the data packets, and experimental requirements for transmission of the various user equipment. Therefore, the curve reflecting the change of energy over time may vary among various user equipment.

FIG. 2 is a graph showing a change of energy of user equipment over time according to an embodiment of the present disclosure. As shown in FIG. 2, a horizontal axis denotes time and a vertical axis denotes energy value. A curve reflecting a change of an energy value of user equipment A over time is different from a curve reflecting a change of an energy value of user equipment B over time.

An electronic device and user equipment in a wireless communication system, a wireless communication method performed by an electronic device in a wireless communication system, a wireless communication method performed by user equipment in a wireless communication system, and a computer readable storage medium are provided according to the present disclosure for such a scenario, to reduce the signaling overhead in an NTN including user equipment that supplies power through energy harvesting, and save energy for the user equipment.

The wireless communication system according to the present disclosure may be a 5G NR (New Radio) communication system. Furthermore, the wireless communication system according to the present disclosure may include a non-terrestrial network (NTN). That is, the wireless communication system may include multiple satellite devices and multiple user equipment. Moreover, the satellite device may be a non-transparent satellite device. That is, a base station device may be arranged on the satellite device, so that the user equipment is allowed to communicate with base station device arranged on the satellite device. The satellite device may also be a transparent satellite device. That is, a base station device may be arranged on a ground device that communicates with the satellite device, so that the user equipment is allowed to communicate with the base station device arranged on the ground through the satellite device.

According to the embodiments of the present disclosure, some user equipment among the user equipment may serve as the relay device. The user equipment may communicate with the satellite device via the relay device, including uplink communication and/or downlink communication. The relay device may buffer data received from one or more user equipment, so as to send the buffered data to the satellite device at an appropriate timing.

According to the embodiments of the present disclosure, some or all of the user equipment may periodically switch between a sleep mode and a wake-up mode with any method commonly known in the art, thereby saving the energy of the user equipment.

The network side device according to the present disclosure may be a base station device, for example, an eNB, or a base station (gNB) in the fifth generation communication system.

The user equipment according to the present disclosure may be a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as a machine type communication (MTC) terminal). In addition, the user equipment may be a wireless communication module (such as an integrated circuit module including a single wafer) installed on each of the terminals described above.

### 2. Configuration Example of a Network Side Device

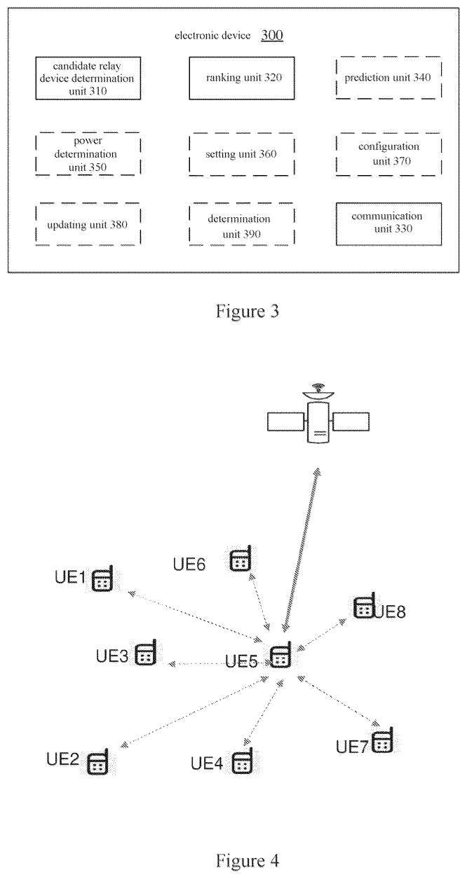

FIG. 3 is a block diagram showing an example of a configuration of an electronic device 300 according to an embodiment of the present disclosure. The electronic device 300 may be used as a network side device in a wireless communication system, and specifically may be used as a base station device in the wireless communication system. In addition, the base station device may be arranged on the satellite device or the ground.

As shown in FIG. 3, the electronic device 300 may include a candidate relay device determination unit 310, a ranking unit 320, and a communication unit 330.

Here, each unit of the electronic device 300 may be included in a processing circuit. It should be noted that the electronic device 300 may include one processing circuitry or multiple processing circuits. Further, the processing circuitry may include various discrete functional units to perform different functions and/or operations. It should be noted that these functional units may be physical entities or logical entities, and units with different names may be implemented by the same physical entity.

According to the embodiments of the present disclosure, the candidate relay device determination unit 310 may determine one or more candidate relay devices for the user equipment. Here, the user equipment may be any user equipment within the coverage of the electronic device 300. In addition, the candidate relay device may convert harvested energy into electrical energy to supply power to the candidate relay device.

According to the embodiments of the present disclosure, the ranking unit 320 may rank one or more candidate relay devices based on energy harvesting capabilities of the one or more candidate relay devices to generate an ordered set of the candidate relay devices.

According to the embodiments of the present disclosure, the electronic device 300 may send the ordered set of the candidate relay devices to the user equipment through the communication unit 330, for the user equipment to determine a relay device according to the ordered set of the candidate relay devices and communicate with the satellite device using the determined relay device.

It can be seen that the electronic device 300 according to the embodiments of the present disclosure can rank the candidate relay devices based on energy harvesting capabilities of the candidate relay devices, for the user equipment to determine a relay device and communicate with the satellite device using the determined relay device. In this way, the user equipment can communicate with the satellite device using the relay device, which reduces energy consumption of the user equipment. In addition, the relay device is required to forward data for multiple user equipment, which requires a lot of energy. Since the relay device is determined based on energy harvesting capability, it can be ensured that the selected relay device has a good energy harvesting capability.

FIG. 4 is a schematic diagram showing a scenario where user equipment communicates with a satellite device using a relay device according to an embodiment of the present disclosure. As shown in FIG. 4, UE1, UE2, UE3, UE4, UE6, UE7, and UE8 each communicates with the satellite device through UE5. Here, UE5 may be referred to as a relay device for UE1, UE2, UE3, UE4, UE6, UE7, and UE8. In addition, UE5 may be configured to forward uplink data, and may also be configured to forward downlink data. That is, UE5 can forward data from UE1, UE2, UE3, UE4, UE6, UE7, and UE8 to the satellite device, and can forward data from the satellite device to UE1, UE2, UE3, UE4, UE6, UE7, and UE8. In this way, energy consumptions of UE1, UE2, UE3, UE4, UE6, UE7, and UE8 can be reduced. In addition, after receiving data, UE5 may not forward the data immediately. Instead, UE5 may wait for an appropriate timing to forward data from multiple UEs together, which reduces the signaling overhead.

According to the embodiments of the present disclosure, as shown in FIG. 3, electronic device 300 may further include a prediction unit 340 configured to predict an energy change curve representing a change of energy of user equipment over time within a predetermined time period in the future.

According to the embodiments of the present disclosure, the prediction unit 340 may predict the energy change curve of the user equipment based on current energy, a change in the energy harvesting capability, and a change in the energy consumption capability of the user equipment.

According to the embodiments of the present disclosure, electronic device 300 may receive, from the user equipment, a current energy value of the user equipment through the communication unit 330. For example, the unit of energy may be Joule.

According to the embodiments of the present disclosure, the prediction unit 340 may determine a change in the energy harvesting capability of the user equipment based on one or more of the following parameters: a position of the user equipment, an energy source of the user equipment, weather conditions associated with the energy source of the user equipment, an antenna parameter of the user equipment, and the energy harvesting capability of the user equipment.

According to the embodiments of the present disclosure, electronic device 300 may receive the position of the user equipment from the user equipment through the communication unit 330, so that the prediction unit 340 can determine the change in the energy harvesting capability of the user equipment based on the position of the user equipment. Specifically, the prediction unit 340 may determine a local geographical condition based on the position of the user equipment, so as to determine the energy harvesting capability of the user equipment. For example, in a case that the user equipment harvests solar energy, the energy harvesting capability on the shaded side of a mountain is inferior to the energy harvesting capability on the sunny side of the mountain.

According to the embodiments of the present disclosure, electronic device 300 may receive the energy source of the user equipment from the user equipment through the communication unit 330, so that the prediction unit 340 can determine the change in the energy harvesting capability of the user equipment based on the energy source of the user equipment. Here, the energy source includes but is not limited to the sun, wind, tides, and geothermal energy.

According to the embodiments of the present disclosure, the electronic device 300 may obtain weather conditions associated with the energy source of the user equipment, so that the prediction unit 340 can determine the change in the energy harvesting capability of the user equipment based on weather conditions associated with the energy source of the user equipment. For example, the electronic device 300 can obtain the above information from institutions such as the meteorological bureau through the network. For example, in a case that the energy source is the sun, the energy harvesting capability of user equipment under an extremely weak lighting condition is inferior to the energy harvesting capability of user equipment under an extremely strong lighting condition.

According to the embodiments of the present disclosure, electronic device 300 may receive the antenna parameter of the user equipment from the user equipment through the communication unit 330, so that the prediction unit 340 can determine the change in the energy harvesting capability of the user equipment based on the antenna parameter of the user equipment. The antenna parameter includes but is not limited to an antenna height, an antenna type, and an antenna emission map.

According to the embodiments of the present disclosure, electronic device 300 may receive the energy harvesting capability of the user equipment from the user equipment through the communication unit 330, so that the prediction unit 340 can determine the change in the energy harvesting capability of the user equipment based on the energy harvesting capability of the user equipment. For example, the energy harvesting capability of the user equipment may be quantified as a value of energy harvested by the user equipment per unit time period under a standard weather condition associated with the energy source. For example, in a case that the energy source is the sun, the energy harvesting capability of the user equipment may be quantified as a value of energy harvested by the user equipment per unit time period under a standard lighting condition. The unit time period includes but is not limited to one day. That is, the energy harvesting capability of the user equipment characterizes the capability of harvesting energy of the user equipment itself, regardless of the weather condition.

As mentioned above, the prediction unit 340 can determine the change in the energy harvesting capability of the user equipment based on one or more of the above parameters. The way in which the prediction unit 340 determines the change in the energy harvesting capability is not limited in the present disclosure. For example, the prediction unit 340 may determine a curve reflecting the change of the harvested energy over time based on one or more of the above parameters.

According to the embodiments of the present disclosure, the prediction unit 340 may determine the change in the energy consumption capability of the user equipment based on one or more of the following parameters: sizes of data packets of the user equipment, a transmission rate of the data packets of the user equipment, a time interval between the data packets of the user equipment, and the requirements of the user equipment for a transmission delay.

According to the embodiments in the present disclosure, the electronic device 300 may receive, from the user equipment through the communication unit 330, one or more of the sizes of the data packets of the user equipment, the transmission rate of the data packets of the user equipment, the time interval between the data packets of the user equipment, and the requirements of the user equipment for a transmission delay, so that the prediction unit 340 can determine a change in the energy consumption capability of the user equipment based on one or more of the above parameters. For example, the larger the sizes of the data packets of the user equipment are, the higher the transmission rate of the data packets is, the shorter the time interval of the data packets is, and the higher the requirements for a transmission delay are, the faster the energy consumption of the user equipment is. The way in which the prediction unit 340 determines the change in the energy consumption capability is not limited in the present disclosure. For example, the prediction unit 340 may determine a curve reflecting the change of the energy consumption over time based on one or more of the above parameters.

According to the embodiments of the present disclosure, the prediction unit 340 may predict an energy change curve of the user equipment based on current energy, the change in the energy harvesting capability, and the change in the energy consumption capability of the user equipment. Furthermore, the electronic device 300 may determine a starting time instant of the energy change curve to be a current time instant, and a difference between an ending time instant and the starting time instant is TO. That is, the prediction unit 340 can predict the energy change curve within a predetermined time period in the future starting from the current time instant.

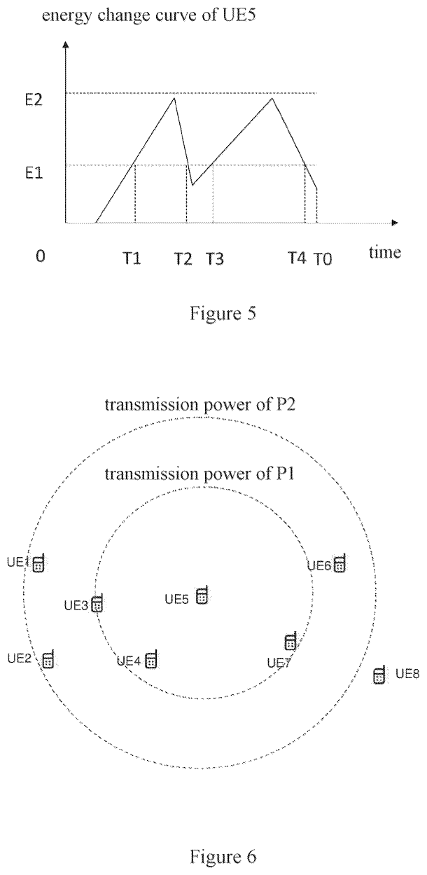

FIG. 5 is a schematic diagram showing an energy change curve according to an embodiment of the present disclosure. As shown in FIG. 5, the horizontal axis denotes time, and the vertical axis denotes the energy change curve of UE5. A starting time instant is 0, and an ending time instant is TO.

According to the embodiments of the present disclosure, as shown in FIG. 3, the electronic device 300 may further include a power determination unit 350 configured to determine a transmission power of the user equipment based on the energy change curve predicted by the prediction unit 340.

According to the embodiments of the present disclosure, the power determination unit 350 may determine the transmission power of the user equipment based on the energy change curve of the user equipment and a mapping relationship between the energy and the transmission power of the user equipment. Here, the electronic device 300 may receive the mapping relationship between the energy and the transmission power of the user equipment from the user equipment through the communication unit 330. Here, each user equipment within the coverage of the electronic device 300 is allowed to adjust a transmission power based on energy. The transmission power is high in a case of high energy, and the transmission power is low in a case of low energy.

According to the embodiments of the present disclosure, the mapping relationship between the energy and the transmission power may be represented as a mapping relationship between energy points and transmission powers, for example, (E1, P1), (E2, P2), (E3, P3), . . . . The user equipment and the electronic device 300 may agree that a transmission power P1 is used in a case that the actual energy of the user equipment is closest to E1, a transmission power P2 is used in a case that the actual energy of the user equipment is closest to E2, and a transmission power P3 is used in a case that the actual energy of the user equipment is closest to E3, . . . . Optionally, the mapping relationship between the energy and the transmission power may also be represented as a mapping relationship between energy ranges and transmission powers, for example, ([0, E1), P1), ([E1, E2), P2), ([E2, E3), P3). The user equipment and the electronic device 300 may agree that the transmission power P1 is used in a case that the actual energy of the user equipment is less than E1, the transmission power P2 is used in a case that the actual energy of the user equipment is greater than or equal to E1 and less than E2, and the transmission power P3 is used in a case that the actual energy of the user equipment is greater than or equal to E2 and less than E3 . . . .

According to the embodiments of the present disclosure, the power determination unit 350 may determine an energy range of the user equipment based on the energy change curve of the user equipment, so as to determine the transmission power of the user equipment based on the energy range and the mapping relationship between the energy and the transmission power of the user equipment. As shown in FIG. 5, an energy range of UE5 is a range that is less than E2. Therefore, in a case that the mapping relationship between energy and transmission power is ([0, E1), P1), ([E1, E2), P2), ([E2, E3), P3), the transmission power of UE5 is P1 before a time instant T1, the transmission power of UE5 is P2 from the time instant T1 to a time instant T2, the transmission power of UE5 is P1 from the time instant T2 to a time instant T3, the transmission power of UE5 is P2 from the time instant T3 to a time instant T4, and the transmission power of UE5 is P1 from the time instant T4 to a time instant TO. That is, the power determination unit 350 may determine the transmission power of the user equipment to be P1 or P2.

According to the embodiments of the present disclosure, the candidate relay device determination unit 310 may determine one or more candidate relay devices for the user equipment based on the transmission power of the user equipment.

According to the embodiments of the present disclosure, the candidate relay device determination unit 310 may determine, for each transmission power among one or more transmission powers of the user equipment, one or more candidate relay devices for the transmission power. That is, the candidate relay device determination unit 310 may determine one or more candidate relay devices for P1, and determine one or more candidate relay devices for P2.

According to the embodiments of the present disclosure, the candidate relay device determination unit 310 may determine, based on the transmission power of the user equipment, a relay device capable of receiving information sent by the user equipment, and determine the relay device capable of receiving the information sent by the user equipment as the candidate relay device for the user equipment.

FIG. 6 is a schematic diagram showing a process of determining the candidate relay device based on the transmission power according to an embodiment of the present disclosure. In FIG. 6, it is assumed that UE3, UE4, UE7, UE1, UE2, and UE6 can serve as the relay devices. As shown in FIG. 6, in a case that the transmission power of UE5 is P1, transmission coverage of UE5 is represented by a dashed line circle on the inside. That is, in a case that the transmission power of UE5 is P1, relay devices that can receive the information sent by UE5 are UE3, UE4, and UE7. Therefore, UE3, UE4, and UE7 are candidate relay devices for P1. In a case that the transmission power of UE5 is P2, transmission coverage of UE5 is represented by a dashed line circle on the outside. Due to a fact that the transmission power P2 is greater than the transmission power P1, the transmission coverage in a case of the transmission power P2 is greater than the transmission range in a case of the transmission power P1. That is, in a case that the transmission power of UE5 is P2, the relay devices that can receive the information sent by UE5 are UE3, UE4, UE7, UE1, UE2, and UE6. Therefore, UE3, UE4, UE7, UE1, UE2, and UE6 are candidate relay devices for P2.

According to the embodiments of the present disclosure, the ranking unit 320 may rank candidate relay devices for each transmission power. For example, for the candidate relay devices UE3, UE4, and UE7 for the transmission power P1, the ranking unit 320 may rank UE3, UE4, and UE7 based on the energy harvesting capabilities of UE3, UE4, and UE7 to generate an ordered set A1. For the candidate relay devices UE3, UE4, UE7, UE1, UE2, and UE6 for the transmission power P2, the ranking unit 320 may rank UE3, UE4, UE7, UE1, UE2, and UE6 based on energy harvesting capabilities of UE3, UE4, UE7, UE1, UE2, and UE6 to generate an ordered set A2.

As mentioned above, the energy harvesting capability of the candidate relay device characterizes an energy value Ec harvested by the candidate relay device per unit time period under a standard weather condition associated with the energy source. Furthermore, the ranking unit 320 may rank a candidate relay device with stronger energy harvesting capability higher. A ranking of a candidate relay device ranked by the ranking unit 320 based on energy harvesting capabilities of the candidate relay devices may be represented by R_{Ec}.

According to the embodiments of the present disclosure, the ranking unit 320 may further rank the candidate relay devices based on one or more of the following parameters of the candidate relay devices: a distance between the candidate relay device and the user equipment, weather conditions associated with the energy source of the candidate relay device, size of buffer of the candidate relay device, the number of user equipment served by the candidate relay device, and quality of connection between the candidate relay device and the satellite device.

According to the embodiments of the present disclosure, the ranking unit 320 may rank a candidate relay device with a smaller distance d from the user equipment higher. A ranking of a candidate relay device ranked by the ranking unit 320 based on distances between the candidate relay devices and the user equipment may be represented by R_{d}.

According to the embodiments of the present disclosure, weather conditions associated with the energy source of the candidate relay device represents an energy value Ce harvested by a standard energy harvesting device per unit time period under the weather condition. That is, Ce characterizes the energy harvesting capability related to weather conditions associated with the energy source of the candidate relay device, and is independent of the energy harvesting capability of the candidate relay device itself. Furthermore, the ranking unit 320 may rank a candidate relay device with a larger Ce higher. A ranking of a candidate relay device ranked by the ranking unit 320 based on the weather conditions associated with the energy sources of the candidate relay devices may be represented by R_{Ce}.

According to the embodiments of the present disclosure, the ranking unit 320 may rank a candidate relay device with a larger buffer size B higher. A ranking of a candidate relay device ranked by the ranking unit 320 based on buffer sizes of the candidate relay devices may be represented by R_{B}.

According to the embodiments of the present disclosure, the ranking unit 320 may rank a candidate relay device that serves a smaller number Na of user equipment higher. A ranking of a candidate relay device ranked by the ranking unit 320 based on numbers of user equipment served by the candidate relay devices may be represented by R_{Na}.

According to the embodiments of the present disclosure, quality of connection between the candidate relay device and the satellite device may be represented by an average receiving power Pa of the candidate relay device during the connection with the satellite device. Furthermore, a candidate relay device with a larger Pa may be ranked higher. A ranking of a candidate relay device ranked by the ranking unit 320 based on qualities of connections between the candidate relay devices and the satellite device may be represented by R_{Pa}.

According to the embodiments of the present disclosure, the ranking unit 320 may rank the candidate relay devices based on one or more of the above parameters, and then determine final ranking Score of a candidate relay device as follows:

Score=a₁*R_{d}+a₂*R_{Ec}+a₃*R_{Ce}+a₄*R_{B}+a₅*R_{Na}+a₆*R_{Pa}.
a₁, a₂, a₃, a₄, a₅ and a₆ represent weights of R_{d}, R_{Ec}, R_{Ce}, R_{B}, R_{Na}, and R_{Pa} in the final ranking score respectively.

An embodiment of the ranking unit 320 determining final ranking scores of the candidate relay devices based on the above-mentioned six parameters is described above, but the present disclosure is not limited thereto. In a case that ranking unit 320 ranks the candidate relay devices based on only some of the parameters, an unused parameter may be removed from the above equation for obtaining the Score.

According to the embodiments of the present disclosure, after the ranking unit 320 determines an order of the candidate relay devices, an ordered set can be obtained. The candidate relay devices in the ordered set are arranged in an order of ranking score from top to bottom. For example, in a case of A1={UE3, UE4, UE7}, a ranking of UE3 is higher than ranking of UE4 and UE7.

According to the embodiments of the present disclosure, after the ranking unit 320 determines an ordered set for each transmission power, the electronic device 300 may send each ordered set to the user equipment through the communication unit 330. Furthermore, the electronic device 300, when transmitting an ordered set, may further transmit a transmission power corresponding to the ordered set simultaneously. For example, the electronic device 300 may send the following information (P1, A1) and (P2, A2) to the user equipment. In this way, the user equipment can determine the correspondence between the ordered set and the transmission power, so as to determine an appropriate ordered set and determine the relay device.

According to the embodiments of the present disclosure, the electronic device 300 may further send positions of the candidate relay devices to the user equipment.

According to the embodiments of the present disclosure, as shown in FIG. 3, the electronic device 300 may further include a setting unit 360.

In a case that the candidate relay device determination unit 310 determines, for each transmission power, that there is no relay device capable of receiving information sent by the user equipment, it indicates that for each transmission power, the candidate relay device determination unit 310 cannot determine a candidate relay device. In this case, the setting unit 360 may determine the user equipment as the relay device. In this way, the user equipment may serve as the relay device to provide a service to other user equipment.

According to the embodiments of the present disclosure, the user equipment may be user equipment that has just accessed in the network, or user equipment that previously accessed in the network but has just woken up from a sleep state. That is, the user equipment may be user equipment to which no relay device is previously allocated, so that the electronic device 300 may perform the above operation to determine a candidate relay device for the user equipment.

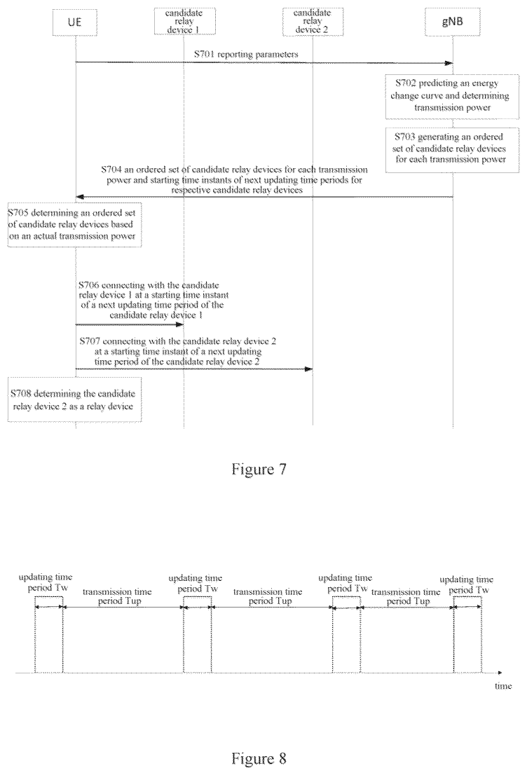

FIG. 7 is a flowchart showing signaling for a process of determining a relay device for user equipment according to an embodiment of the present disclosure. In FIG. 7, the gNB may be implemented by the electronic device 300, and UE may be user equipment that is not allocated with a relay device previously. As shown in FIG. 7, in step S701, the UE accesses in a network or wakes up from a sleep state. The UE reports parameters to the gNB, and the parameters include but are not limited to a position of the user equipment, an energy source of the user equipment, an antenna parameter of the user equipment, an energy harvesting capability of the user equipment, sizes of data packets of the user equipment, a transmission rate of the data packets of the user equipment, and a time interval between the data packets of the user equipment, and the requirements of the user equipment for a transmission delay. Next, in step S702, the gNB predicts an energy change curve of the UE based on the parameters reported by the UE, and determines one or more transmission powers based on the energy change curve. Next, in step S703, the gNB determines one or more candidate relay devices for each transmission power and generates an ordered set of the candidate relay devices. Next, in step S704, the gNB sends, to the UE, an ordered set of candidate relay devices for each transmission power, positions of the candidate relay devices, and starting time instants of next updating time periods for the candidate relay devices. In step S705, the UE determines an actual transmission power based on an actual energy and selects an ordered set of candidate relay devices based on the actual transmission power. Here, it is assumed that the ordered set of candidate relay devices determined by the UE includes a candidate relay device 1 and a candidate relay device 2, with the candidate relay device 1 ranked higher than the candidate relay device 2. In step S706, the UE attempts to connect with the candidate relay device 1 at a starting time instant of a next updating time period of the candidate relay device 1. Here, it is assumed that the UE fails in connecting with the candidate relay device 1. In step S707, the UE attempts to connect with the candidate relay device 2 at a starting time instant of a next updating time period of the candidate relay device 2. Here, it is assumed that the UE1 succeeds in connecting with the candidate relay device 2. In step S708, the UE determines the candidate relay device 2 as a relay device, so as to communicate with a satellite device through the candidate relay device 2. As mentioned above, with the assistance of the gNB, the UE can determine an relay device appropriately, thereby saving energy and signaling overhead.

As mentioned above, according to the embodiments of the present disclosure, electronic device 300 can predict the energy change curve of the user equipment and generate different ordered sets of candidate relay devices based on different transmission powers. In this way, the user equipment can select an ordered set of candidate relay devices based on the actual transmission power, and determine the relay device from the ordered set, thereby saving signaling overhead and energy. The ordered set of candidate relay devices is related to energy harvesting capabilities of the candidate relay devices, so that the user equipment can select a relay device with sufficient energy. Furthermore, the user equipment can adjust the transmission power based on a change in energy, so as to ensure sufficient energy to transmit data. In addition, in a case that a candidate relay device cannot be determined, the electronic device 300 may determine the user equipment as a relay device, so as to provide service to other user equipment around the user equipment determined as the relay device.

According to the embodiments of the present disclosure, as shown in FIG. 3, the electronic device 300 may further include a configuration unit 370 configured to configure, for each relay device, an updating time period, a transmission time period, and a starting time instant of a first updating time period.

According to the embodiments of the present disclosure, each relay device may periodically enter the updating time period and the transmission time period according to configuration of the electronic device 300. During the updating time period, the relay device establishes a connection with a core network through the satellite device. During the transmission time period, the relay device communicates with the user equipment or with the satellite device.

FIG. 8 is a schematic diagram showing an updating time period and a transmission time period of a relay device according to an embodiment of the present disclosure. As shown in FIG. 8, on a time axis, the relay device periodically enters the updating time period Tw and the transmission time period Tup. A sum of one updating time period Tw and one transmission time period Tup may be referred to as a cycle. Generally, cycles of the relay device are the same in length. That is, all updating time periods Tw are the same in length, and all transmission time periods Tup are the same in length. Cycles of the relay device may also be slightly different in length. For example, a length of the transmission time period Tup may be adjusted to Tup±Δt, where Δt represents an adjustment amount.

According to the embodiments of the present disclosure, during the updating time period, the relay device may establish a connection with the core network through the satellite device. For example, the relay device may establish a connection with a core network on the ground through a base station device arranged on the satellite device, and the relay device may also establish a connection with a base station device on the ground through the satellite device so as to establish a connection with the core network on the ground. During the updating time period, the relay device may further exchange signaling with the user equipment served by the relay device. In addition, during the updating time period, user equipment to which a relay device is just allocated may also establish a connection with the relay device, or user equipment for which the relay device is updated may also establish a connection with the updated relay device. That is, during the updating time period, all transmission except the data transmission can be performed.

According to the embodiments of the present disclosure, the configuration unit 370 may determine the length of the updating time period based on the number of user equipment served by the relay device. Specifically, the larger the number of user equipment which the relay device serves is, the longer the length of the updating time period for the relay device is.

According to the embodiments of the present disclosure, the configuration unit 370 may determine the starting time instant of each updating time period of the relay device based on ephemeris of the satellite devices. For example, the configuration unit 370 may determine the starting time instants of the updating time periods, so that there is a satellite device that can provide service above the relay device during each updating time period. In this way, during the updating time period, the relay device can exchange information with the satellite device with high quality. Furthermore, the electronic device 300 may send a starting time instant of any one updating time period to the relay device, so that the relay device can determine the starting time instants of the updating time periods based on the starting time instant of any one updating time period, the length of the updating time period, and the length of the transmission time period. The starting time instant of any one updating time period here may include a starting time instant of an updating time period before a current time instant and a starting time instant of an updating time period after the current time instant. Preferably, the starting time instant of the updating time period sent by electronic device 300 to the relay device may be a starting time instant of an updating time period that is after the current time instant and closest to the current time instant, that is, a starting time instant of a next updating time period from the current time instant.

According to the embodiments of the present disclosure, the configuration unit 370 may determine the length of the transmission time period based on the energy consumption capability of the relay device. Specifically, the configuration unit 370 may configure a shorter transmission time period for a relay device with faster energy consumption. In addition, the configuration unit 370 may further determine the length of the transmission time period based on the ephemeris of the satellite devices. For example, the configuration unit 370 may adjust the length of the transmission time period to ensure that there is a satellite device that can provide a service above the relay device at a next updating time period.

According to the embodiments of the present disclosure, the configuration unit 370 may configure the above parameters for each user equipment serving as a relay device. Furthermore, in the case that the setting unit 360 sets the user equipment as a relay device, the configuration unit 370 may also configure the above parameters for the user equipment.

According to the embodiments of the present disclosure, in a case that the electronic device 300 sends an ordered set of candidate relay devices for each transmission power to the user equipment, the electronic device 300 may further send the starting time instant of the next updating time period of each candidate relay device to the user equipment. In this way, the user equipment may attempt to connect with the candidate relay device at the starting time instant of the next updating time period of the candidate relay device.

According to the embodiments of the present disclosure, as shown in FIG. 3, the electronic device 300 may further include an updating unit 380 configured to update each relay device during the updating time period of the relay device.

According to the embodiments of the present disclosure, during the updating time period of each relay device, the electronic device 300 may establish a connection with the relay device. Furthermore, the electronic device 300 may receive, through communication unit 330, current energy of the relay device, an energy harvesting capability of the relay device, current energy of each user equipment served by the relay device, and an energy harvesting capability of each user equipment served by the relay device.

According to the embodiments of the present disclosure, during the updating time period of each relay device, the relay device and all user equipment served by the relay device wake up from a sleep mode. Furthermore, the relay device may send an energy reporting notification to the user equipment through broadcast, so that each user equipment reports a current energy value and an energy harvesting capability to the relay device. In this way, the relay device can send the current energy and the energy harvesting capability of each user equipment, along with the current energy and the energy harvesting capability of the relay device itself, to the electronic device 300.

According to the embodiments of the present disclosure, the updating unit 380 may divide the user equipment served by the relay device into user equipment groups based on the information received from the relay device, and determine a target relay device for each of the user equipment groups. Furthermore, the electronic device 300 may send a result of dividing the user equipment into user equipment groups and the target relay devices for the user equipment groups to the relay device (for ease of distinguishing, the relay device is also referred to as a source relay device) through the communication unit 330.

According to the embodiments of the present disclosure, the updating unit 380 may determine a target relay device from among the source relay device and the user equipment that is served by the source relay device and meets a condition of the relay device. Here, there may be one target relay device or multiple target relay devices. In a case that there are multiple target relay devices, the updating unit 380 may further determine the user equipment served by each target relay device. That is, all user equipment is divided into groups.

According to the embodiments of the present disclosure, as shown in FIG. 3, the electronic device 300 may further include a determination unit 390 configured to determine whether user equipment meets the condition of a relay device, that is, whether the user equipment can serve as a relay device. Furthermore, the determination unit 390 may determine whether each user equipment served by the source relay device meets the condition of the relay device, so that the updating unit 380 can determine the target relay device from among the source relay device and the user equipment that is served by the source relay device and meets the condition of the relay device.

According to the embodiments of the present disclosure, it is determined that user equipment meets the condition of a relay device in a case that the user equipment meets one or more of the following conditions. 1) Quality of connection between the user equipment and the satellite device is greater than a first predetermined threshold. 2) Quality of connection between the user equipment and a predetermined number of other user equipment is greater than a second predetermined threshold. 3) A buffer size of the user equipment is greater than a third predetermined threshold. 4) Remaining energy of the user equipment during a time period in the future is greater than a fourth predetermined threshold.

According to the embodiments of the present disclosure, the relay device is required to forward data between the user equipment and the satellite device, which requires good quality of the connection between the user equipment serving as the relay device and the satellite device. Furthermore, the relay device is required to provide service to the user equipment, which requires good quality of the connection between the relay device and a predetermined number of other user equipment around the relay device. In addition, the relay device is required to buffer data from the user equipment, which requires sufficient buffer space. Furthermore, the relay device is required to consume a large amount of energy, so that the relay device is required to have sufficient energy during a time period in the future. Here, the time period in the future may refer to the transmission time period of the relay device, that is, a time period before the next updating time period of the relay device comes.

According to the embodiments of the present disclosure, the determination unit 390 may determine the remaining energy of the user equipment during a time period in the future, based on the current energy value of the user equipment, energy to be harvested during a time period in the future determined based on the energy harvesting capability of the user equipment, energy consumed in sending data, energy consumed in receiving data, and energy consumed by a circuit of the user equipment itself. Furthermore, in a case that the remaining energy is greater than the fourth predetermined threshold, the determination unit 390 may determine that the user equipment meets the above condition 4).

Specifically, the remaining energy of the user equipment during a time period in the future may be expressed as the following expression: E₀+E_{g}−Nᵣ×Dᵣ×α−Nₜ×Dₜ×β−E_{b}.

In the above equation, E₀ represents the current energy value of the user equipment, E_{g} represents the energy to be harvested during a time period in the future determined based on the energy harvesting capability of the user equipment, Nᵣ represents the average number of times of receiving data, Dᵣ represents an average amount of data received each time, a represents the energy consumed in receiving per unit of data, Nₜ represents the average number of times of sending data, Dₜ represents an average amount of data sent each time, β represents the energy consumed in sending per unit of data, and E_{b} represents average energy consumed by the circuit of the user equipment itself, that is, energy consumed in a case of neither sending data nor receiving data.

Furthermore, in a case of E₀+E_{g}−Nᵣ×Dᵣ×α−Nₜ×Dₜ×β−E_{b}>Eₜₕ, the determination unit 390 may determine that the user equipment meets the above condition 4), where Eₜₕ represents the fourth predetermined threshold.

According to the embodiments of the present disclosure, the updating unit 380 may determine the target relay device from among the source relay device and the user equipment that is served by the source relay device and meets the condition of the relay device.

Furthermore, the updating unit 380 may select the target relay device based on the remaining energy of each user equipment during a time period in the future and the remaining energy of the source relay device during the time period in the future. For example, the updating unit 380 may calculate the remaining energy of each user equipment and the source relay device during a time period in the future according to the expression E₀+E_{g}−Nᵣ×Dᵣ×α−Nₜ×Dₜ×β−E_{b}, so as to select a device with the most remaining energy as the target relay device.

According to the embodiments of the present disclosure, in a case that the updating unit 380 determines that the device with the most remaining energy is still the source relay device, the updating unit 380 may determine the target relay device as the source relay device. In this case, it is unnecessary to divide the user equipment into groups. That is, all user equipment is divided into a same group, and all user equipment is still served by the source relay device. In this case, the electronic device 300 may send a result indicating that it is unnecessary to change the groups or to change the target relay device to the source relay device, so that the source relay device sends the information to each user equipment through broadcast.

According to the embodiments of the present disclosure, in a case that the updating unit 380 determines that the device with the most remaining energy is user equipment, the updating unit 380 may determine that the target relay device is the user equipment, and other user equipment and the source relay device are divided into a same group and are served by the user equipment. In this case, the electronic device 300 may send a result indicating that it is unnecessary to change the groups and that the target relay device is the user equipment to the source relay device, so that the source relay device sends the information to each user equipment through broadcast. Then, other user equipment attempts to connect with the target relay device. In a case that the user equipment succeeds in connecting with the target relay device, the user equipment is served by the target relay device. In a case that the user equipment fails in connecting with the target relay device, the user equipment reports to the electronic device 300, and the electronic device 300 may determine an ordered set of candidate relay devices for the user equipment for the user equipment to select a relay device.

According to the embodiments of the present disclosure, the updating unit 380 may also determine the target relay device by combining remaining energy and other parameters. Other parameter includes but are not limited to quality of connection between the user equipment and a predetermined number of user equipment around the user equipment, and a buffer size of the user equipment. For example, the updating unit 380 determines that quality of the connection between user equipment A and a portion of other user equipment is good, a buffer size of the user equipment A can support data of the portion of the user equipment, and the user equipment A has a large amount of remaining energy, and determines that qualities of connection between the user equipment B and another portion of other user equipment and connection between the user equipment B and the source relay device are good, and a buffer size of the user equipment B can support the other portion of other user equipment and the source relay device, and the user equipment B has a large amount of remaining energy. Then the updating unit 380 may determine the user equipment A as a target relay device for a portion of other user equipment, and determines the user equipment B as a target relay device for another portion of other user equipment and the source relay device. That is, a portion of other user equipment is divided into a group, and another portion of other user equipment and the source relay device are divided into another group. In this case, the electronic device 300 may send the above dividing result and the target relay device for each group to the source relay device, so that the source relay device can send, to each of different groups, the target relay device for the group through multicast. Then, each user equipment attempts to connect with the target relay device for the user equipment. In a case that the user equipment succeeds in connecting with the target relay device, the user equipment is served by the target relay device. In a case that the user equipment fails in connecting with the target relay device, the user equipment reports to the electronic device 300 and the electronic device 300 may determine an ordered set of candidate relay devices for the user equipment for the user equipment to select a relay device.

According to the embodiments of the present disclosure, the updating unit 380 may also determine the target relay device from among user equipment not belonging to the user equipment served by the source relay device. That is, the updating unit 380 may also set the source relay device and all user equipment to be served by user equipment in another group. For example, the updating unit 380 may calculate remaining energy of each user equipment and the source relay device during a time period in the future and calculate remaining energy of one or more user equipment from another group during a time period in the future according to an expression E₀+E_{g}−Nᵣ×Dᵣ×α−Nₜ×Dₜ×β−E_{b}, so as to select a device with the most remaining energy as the target relay device.

According to the embodiments of the present disclosure, the updating unit 380 may further determine whether it is required to change the transmission time period of the relay device. For example, the updating unit 380 may determine whether the transmission time period of the target relay device is the same as the transmission time period of the source relay device. In a case that the transmission time period of the target relay device is different from the transmission time period of the source relay device, the electronic device 300 may further send the transmission time period of the target relay device to the source relay device, so that the source relay device forwards the transmission time period to the user equipment. Furthermore, in a case that the target relay device is different from the source relay device, the electronic device 300 may further send the starting time instant of the next updating time period of the target relay device to the source relay device, so that the source relay device forwards the information to the user equipment. In this way, the user equipment can attempt to establish a connection with the target relay device at the starting time instant of the next updating time period of the target relay device. In addition, the electronic device 300 may further send weather conditions associated with various energy sources to the source relay device, so that the source relay device forwards the information to the user equipment.

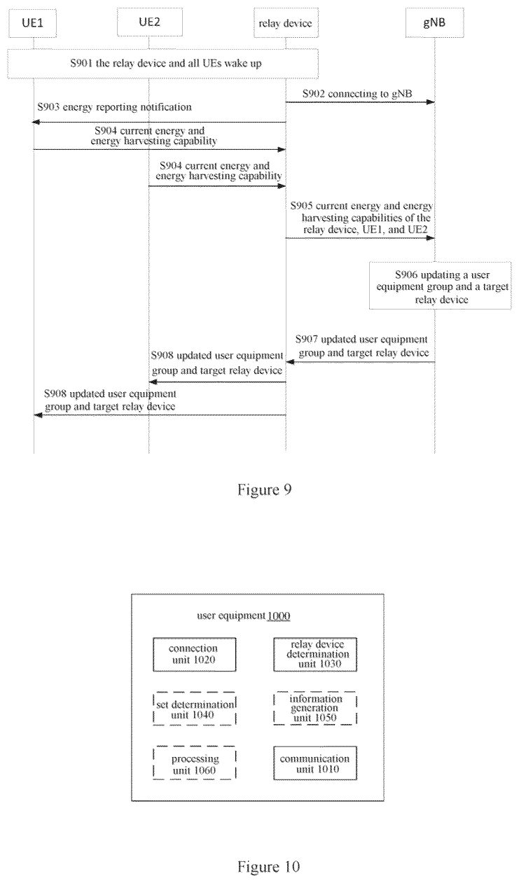

FIG. 9 is a flowchart showing signaling for a process of updating a user equipment group and a relay device according to an embodiment of the present disclosure. In FIG. 9, the gNB may be implemented by the electronic device 300. UE1 and UE2 perform communication with a satellite device through a relay device. As shown in FIG. 9, in step S901, at the starting time instant of the updating time period of the relay device, the relay device, the UE1, and the UE2 wake up. In step S902, the relay device is connected to the gNB. In step S903, the relay device sends an energy report notification through broadcast. In step S904, the UE1 and the UE2 each reports current energy and an energy harvesting capability to the relay device. In step S905, the relay device sends current energy and an energy harvesting capability of the relay device, current energy and an energy harvesting capability of the UE1, and current energy and an energy harvesting capability of the UE2 to the gNB. In step S906, the gNB updates a user equipment group and a target relay device based on the received information. In step S907, the gNB sends the updated user equipment group and target relay device to the relay device. In step S908, the relay device sends the updated user equipment group and target relay device to the user equipment through broadcast or multicast. All steps in FIG. 9 are completed within the updating time period of the relay device. As shown in FIG. 9, the gNB may update the user equipment group and the relay device during the updating time period of the relay device.

It can be seen that according to the embodiments in the present disclosure, the relay device may periodically enter the updating time period and transmission time period alternately. During the updating time period, the relay device can interact with the satellite device and network side device in high quality due to good quality of connection with the satellite device. During the transmission time period, data may be transmitted between the relay device and the satellite device or between the relay device and the user equipment. Furthermore, during the updating time period, the electronic device 300 may update the target relay device and the user equipment group based on the remaining energy of each device during a time period in the future, to always select a device with sufficient energy as the relay device, so as to serve the user equipment better. In addition, the electronic device 300 may further send weather conditions associated with the energy source to the relay device, so that each user equipment can predict energy of the user equipment based on the information, so as to change the transmission power based on the energy, thereby saving energy.

### 3. Configuration Example of User Equipment

FIG. 10 is a block diagram showing structure of user equipment 1000 in a wireless communication system according to an embodiment of the present disclosure. As shown in FIG. 10, the user equipment 1000 may include a communication unit 1010, a connection unit 1020, and a relay device determination unit 1030.

Here, each unit of the user equipment 1000 may be included in a processing circuit. It should be noted that the user equipment 1000 may include one processing circuitry or multiple processing circuits. Further, the processing circuitry may include various discrete functional units to perform different functions and/or operations. It should be noted that these functional units may be physical entities or logical entities, and units with different names may be implemented by the same physical entity.

According to the embodiments of the present disclosure, user equipment 1000 may receive an ordered set of candidate relay devices from a network side device through the communication unit 1010. The ordered set of candidate relay devices is generated by ranking one or more candidate relay devices based on energy harvesting capabilities of the one or more candidate relay devices. Here, the candidate relay device converts harvested energy into electrical energy to supply power to the candidate relay device.

According to the embodiments of the present disclosure, the connection unit 1020 may sequentially perform connection with the candidate relay devices in the ordered set of candidate relay devices according to an order in the ordered set of candidate relay devices until successful connecting with a candidate relay device.

According to the embodiments of the present disclosure, the relay device determination unit 1030 may determine the candidate relay device in successful connection as a relay device.

According to the embodiments of the present disclosure, user equipment 1000 may communicate with a satellite device through the communication unit 1010 using the relay device determined by the relay device determination unit 1030.

As mentioned above, according to the embodiments of the present disclosure, the user equipment 1000 may communicate with the satellite device using the relay device, so as to save energy of the user equipment 1000. Furthermore, the relay device is determined from among the ordered set of candidate relay devices, and the ordered set of candidate relay devices is generated by ranking the candidate relay devices based on energy harvesting capabilities of the candidate relay devices, which can ensure that the selected relay device has sufficient energy.

According to the embodiments of the present disclosure, there may be multiple ordered sets of candidate relay devices received by the user equipment 1000 from the network side device through the communication unit 1010, and each ordered set of candidate relay devices corresponds to one transmission power of the user equipment 1000. That is, the user equipment 1000 may receive multiple ordered sets of candidate relay devices and transmission powers corresponding to respective ordered sets.

According to the embodiments of the present disclosure, user equipment 1000 may determine an actual transmission power based on actual energy of the user equipment 1000. Specifically, in a case of a larger actual energy of the user equipment 1000, the user equipment 1000 has a larger transmission power. In this way, the user equipment 1000 may adjust the transmission power based on the amount of the energy, thereby saving energy consumption.

According to the embodiments of the present disclosure, as shown in FIG. 10, the user equipment 1000 may further include a set determination unit 1040 configured to determine, based on an actual transmission power of the user equipment, an ordered set of candidate relay devices corresponding to the actual transmission power. Specifically, the set determination unit 1040 may determine a transmission power that is closest to and less than the actual transmission power, and determine an ordered set of candidate relay devices corresponding to the transmission power as the ordered set of candidate relay devices corresponding to the actual transmission power. For example, in the example shown in FIG. 6, the ordered set of candidate relay devices corresponding to P1 is A1, and the ordered set of candidate relay devices corresponding to P2 is A2. In a case that the actual transmission power of the user equipment 1000 is greater than or equal to P1 and less than P2, the set determination unit 1040 may determine the ordered set A1. In a case that the actual transmission power of the user equipment 1000 is greater than or equal to P2 and less than P3 (located on the outer side of P2, not shown), the set determination unit 1040 may determine the ordered set A2.

According to the embodiments of the present disclosure, the user equipment 1000 may further receive a position of each candidate relay device from the network side device through the communication unit 1010.

According to the embodiments of the present disclosure, the user equipment 1000 may further receive a starting time instant of a next updating time period for each candidate relay device from the network side device through the communication unit 1010. As mentioned above, each candidate relay device periodically enters the updating time period and transmission time period. During the updating time period, the candidate relay device establishes a connection with a core network through a satellite device, and during the transmission time period, the candidate relay device communicates with the user equipment or the candidate relay device communicates with a satellite device.

According to the embodiments of the present disclosure, the connection unit 1020 may sequentially perform connection with the candidate relay devices in the ordered set of candidate relay devices at the starting time instant of the next updating time period of the candidate relay device according to an order in the ordered set of candidate relay devices until successful connection with a candidate relay device.

For example, in a case that the set determination unit 1040 determines an ordered set A1 and A1={UE3, UE4, UE7}, the user equipment 1000 may attempt to connect with UE3 at the starting time instant of the next updating time period of UE3. In a case that the user equipment 1000 fails in connecting with UE3, the user equipment 1000 may attempt to connect with UE4 at the starting time instant of the next updating time period of UE4. In a case that the user equipment 1000 succeeds in connecting with UE4, the relay device determination unit 1030 may determine UE4 as the relay device for the user equipment 1000 without the need of performing connection with UE7.

According to the embodiments of the present disclosure, as shown in FIG. 10, the user equipment 1000 may further include an information generation unit 1050 configured to generate various types of information. For example, the user equipment 1000 may generate, when just accessed in the network or waking up from a sleep state, information required to be reported to the network side device. The information may include one or more of the following parameters: a position of the user equipment, current energy of the user equipment, an energy source of the user equipment, a mapping relationship between energy and transmission power of the user equipment, an antenna parameter of the user equipment, sizes of data packets of the user equipment, a transmission rate of the data packets of the user equipment, an time interval between the data packets of the user equipment, and requirements of the user equipment for a transmission delay. In this way, the network side devices can determine an ordered set of candidate relay devices for the user equipment 1000 using the above information.

According to the embodiments of the present disclosure, the user equipment 1000 may receive information indicating that the user equipment 1000 serves as a relay device from the network side device through the communication unit 1010, instead of receiving the ordered set of candidate relay devices from the network side device. Furthermore, the user equipment 1000 may further receive an updating time period, a transmission time period, and a starting time instant of a first updating time period of the user equipment from the network side device through the communication unit 1010. The starting time instant of the first updating time period here is preferably a starting time instant of a next updating time period from a current time instant.

According to the embodiments of the present disclosure, as shown in FIG. 10, the user equipment 1000 may further include a processing unit 1060 configured to periodically enter, based on the updating time period, the transmission time period, and the starting time instant of the first updating time period sent by the network side device, the updating time period and transmission time period. Here, during the updating time period, the user equipment 1000 establishes a connection with a core network through a satellite device, and during the transmission time period, the user equipment 1000 communicates with other user equipment served by the user equipment 1000 or the user equipment 1000 communicates with a satellite device.

According to the embodiments of the present disclosure, after the user equipment 1000 determines the relay device, the user equipment 1000 may wake up from a sleep state at the starting time instant of each updating time period of the relay device and receive an energy reporting notification from the relay device through the communication unit 1010. Furthermore, the information generation unit 1050 may generate information indicating current energy and the energy harvesting capability of the user equipment 1000, so that the user equipment 1000 sends the current energy and the energy harvesting capability of the user equipment 1000 to the relay device through the communication unit 1010.

According to the embodiments of the present disclosure, after the user equipment 1000 determines the relay device, the user equipment 1000 may further receive the target relay device from the relay device through the communication unit 1010. Furthermore, the connection unit 1020 may be connected with the target relay device, so that the user equipment 1000 is served by the target relay device rather than the original relay device.

According to the embodiments of the present disclosure, user equipment 1000 may further receive a starting time instant of a next updating time period of the target relay device from the relay device through the communication unit 1010, so that the user equipment 1000 may attempt to connect with the target relay device at the starting time instant of the next updating time period of the target relay device. In a case that the user equipment 1000 fails in connecting with the target relay device, the user equipment 1000 may send information indicating a failure in connection to the network side device, so as to receive an ordered set of candidate relay devices from the network side device and re-determine a relay device by the relay device determination unit 1030.

According to the embodiments of the present disclosure, the user equipment 1000 may further receive weather conditions associated with an energy source of the user equipment 1000 from the relay device through the communication unit 1010, so that the user equipment 1000 can predict a change in energy of the user equipment 1000 using the information, so as to adjust the transmission power in time.

As mentioned above, the user equipment 1000 according to the embodiments of the present disclosure may communicate with a satellite device using a delay device, thereby saving energy. In addition, the user equipment 1000 may report information to the network side device for the network side device to determine an ordered set of candidate relay devices. In a case of a change in the relay device, the user equipment 1000 may connect with the target relay device based on the information of the source relay device, which ensures that the user equipment can always be connected to a relay device with sufficient energy.

### 4. Method Embodiments

Next, a wireless communication method performed by the electronic device 300 as a network side device in a wireless communication system according to an embodiment of the present disclosure is described in detail.

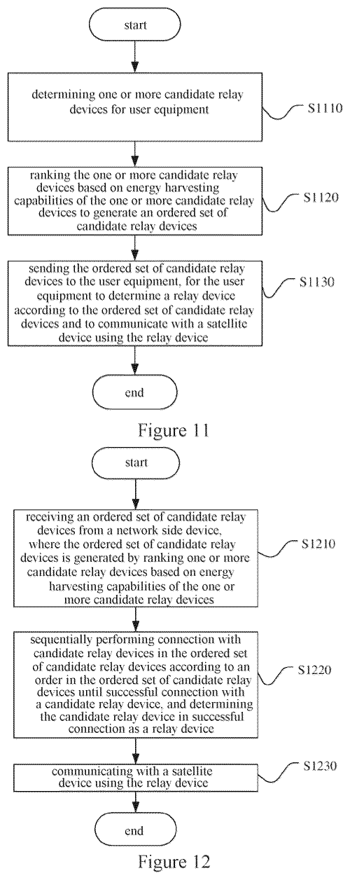

FIG. 11 is a flowchart of a wireless communication method performed by the electronic device 300 as a network side device in a wireless communication system according to an embodiment of the present disclosure.

As shown in FIG. 11, in step S1110, one or more candidate relay devices for user equipment are determined. Here, the candidate relay device converts harvested energy into electrical energy to supply power to the candidate relay device.

Next, in step S1120, one or more candidate relay devices are ranked based on energy harvesting capabilities of the one or more candidate relay devices to generate an ordered set of candidate relay devices.

Next, in step S1130, the ordered set of candidate relay devices is sent to the user equipment, for the user equipment to determine a relay device according to the ordered set of candidate relay devices and to communicate with a satellite device using the relay device.

Preferably, the wireless communication method further includes: predicting an energy change curve reflecting a change of energy of the user equipment over time within a predetermined time period in the future; determining a transmission power of the user equipment according to the energy change curve; and determining the one or more candidate relay devices for the user equipment based on the transmission power of the user equipment. The user equipment converts harvested energy into electrical energy to supply power to the user equipment.

Preferably, the wireless communication method further includes: determining, for each transmission power of one or more transmission powers of the user equipment, one or more candidate relay devices for the transmission power.

Preferably, the predicting an energy change curve includes: predicting the energy change curve based on current energy, a change in energy harvesting capability, and a change in energy consumption capability of the user equipment.

Preferably, the determining a change in the energy harvesting capability of the user equipment includes: determining the change in the energy harvesting capability of the user equipment based on one or more of the following parameters: a position of the user equipment, an energy source of the user equipment, weather conditions associated with the energy source of the user equipment, an antenna parameter of the user equipment, and energy harvesting capability of the user equipment.

Preferably, the determining a change in the energy consumption capability of the user equipment includes: determining the change in the energy consumption capability of the user equipment based on one or more of the following parameters: sizes of data packets of the user equipment, a transmission rate of the data packets of the user equipment, a time interval between data packets of the user equipment, and requirements of the user equipment for a transmission delay.

Preferably, the determining a transmission power of the user equipment includes: determining the transmission power of the user equipment based on the energy change curve of the user equipment and a mapping relationship between the energy and the transmission power of the user equipment.

Preferably, the determining one or more candidate relay devices for the user equipment based on the transmission power of the user equipment include: determining a relay device capable of receiving information sent by the user equipment based on the transmission power of the user equipment; and determining the relay device capable of receiving the information sent by the user equipment as the candidate relay device for the user equipment.

Preferably, the wireless communication method further includes: determining, in a case of there is no relay device capable of receiving the information sent by the user equipment, the user equipment as the relay device.

Preferably, the ranking one or more candidate relay devices includes: ranking the one or more candidate relay devices further based on one or more of the following parameters: a distance between the candidate relay device and the user equipment, weather conditions associated with an energy source of the candidate relay device, a buffer size of the candidate relay device, the number of user equipment served by the candidate relay device, and quality of connection between the candidate relay device and the satellite device.

Preferably, the wireless communication method further includes: setting, for each relay device, an updating time period, a transmission time period, and a starting time instant of a first updating time period to enable the relay device to periodically enter the updating time period and the transmission time period. During the updating time period, the relay device establishes a connection with a core network through the satellite device, and during the transmission time period, the relay device communicates with the user equipment or the relay device communicates with the satellite device.

Preferably, the wireless communication method further includes: determining a length of the updating time period based on the number of user equipment served by the relay device.

Preferably, the wireless communication method further includes: determining a length of the transmission time period based on an energy consumption capability of the relay device and an ephemeris of each satellite device.

Preferably, the wireless communication method further includes: sending a starting time instant of a next updating time period of each candidate relay device to the user equipment.

Preferably, the wireless communication method further includes: establishing, during the updating time period of each relay device, a connection with the relay device; receiving, from the relay device, current energy of the relay device, an energy harvesting capability of the relay device, current energy of each user equipment served by the relay device, and an energy harvesting capability of each user equipment served by the relay device; dividing the user equipment served by the relay device into user equipment groups based on the information received from the relay device, and determining a target relay device for each of the user equipment groups; and sending a result of dividing the user equipment into user equipment groups and the target relay device for each of the user equipment groups to the relay device.

Preferably, the dividing the user equipment served by the relay device into user equipment groups and determining a target relay device for each of the user equipment groups includes: determining the target relay device from among the relay device and the user equipment that is served by the relay device and meets a condition of the relay device. It is determined that the user equipment meets the condition of the relay device in a case that the user equipment meets one or more of the following conditions: quality of connection between the user equipment and the satellite device is greater than a first predetermined threshold; quality of connection between the user equipment and a predetermined number of other user equipment is greater than a second predetermined threshold; a buffer size of the user equipment is greater than a third predetermined threshold; and remaining energy of the user equipment during a time period in the future is greater than a fourth predetermined threshold.

Preferably, the dividing the user equipment served by the relay device into user equipment groups and determining a target relay device for each of the user equipment groups includes: determining the target relay device from among user equipment not belonging to the user equipment served by the relay device.

According to the embodiments of the present disclosure, a subject that performs the above method may be the electronic device 300 according to the embodiments of the present disclosure, so all the previous embodiments regarding the electronic device 300 are applicable herein.

Next, a wireless communication method performed by the user equipment 1000 in a wireless communication system according to an embodiment of the present disclosure is described in detail.

FIG. 12 is a flowchart of a wireless communication method performed by the user equipment 1000 in a wireless communication system according to an embodiment of the present disclosure.

As shown in FIG. 12, in step S1210, an ordered set of candidate relay devices is received from a network side device. The ordered set of candidate relay devices is generated by ranking one or more candidate relay devices based on energy harvesting capabilities of the one or more candidate relay devices. Furthermore, the candidate relay device converts harvested energy into electrical energy to supply power to the candidate relay device.

Next, in step S1220, connection is sequentially performed with candidate relay devices in the ordered set of candidate relay devices according to an order in the ordered set of candidate relay devices until successful connection with a candidate relay device. The candidate relay device in successful connection is determined as a relay device.

Next, in step S1230, communication is performed with the satellite device using the relay device.

Preferably, the wireless communication method further includes: receiving the ordered set of the one or more candidate relay devices from the network side device, where each ordered set of candidate relay devices corresponds to one transmission power of the user equipment; and determining, based on an actual transmission power of the user equipment, an ordered set of candidate relay devices corresponding to the actual transmission power.

Preferably, the wireless communication method further includes: sending, to the network side device, one or more of the following parameters: a position of the user equipment, current energy of the user equipment, an energy source of the user equipment, a mapping relationship between energy and transmission power of the user equipment, an antenna parameter of the user equipment, an energy harvesting capability of the user equipment, sizes of data packets of the user equipment, a transmission rate of the data packets of the user equipment, a time interval between the data packets of the user equipment, and requirements of the user equipment for a transmission delay.

Preferably, the wireless communication method further includes: receiving, from the network side device, a starting time instant of a next updating time period of each candidate relay device; and sequentially performing connection with candidate relay devices in the ordered set of candidate relay devices at the starting time instant of the next updating time period of the candidate relay device according to an order in the ordered set of candidate relay devices until successful connection with a candidate relay device. Each candidate relay device periodically enters the updating time period and the transmission time period. During the updating time period, the candidate relay device establishes a connection with a core network through a satellite device, and during the transmission time period, the candidate relay device communicates with the user equipment or the candidate relay device communicates with a satellite device.

Preferably, the wireless communication method further includes: receiving, from the network side device, information indicating that the user equipment serves as a relay device; receiving, from the network side device, an updating time period, a transmission time period, and a starting time instant of the first updating time period of the user equipment; and periodically entering the updating time period and transmission time period. During the updating time period, the user equipment establishes a connection with a core network through a satellite device, and during the transmission time period, the user equipment communicates with other user equipment served by the user equipment or the user equipment communicates with a satellite device.

Preferably, the wireless communication method further includes: receiving an energy reporting notification from the relay device; and sending current energy and an energy harvesting capability of the user equipment to the relay device.

Preferably, the wireless communication method further includes: receiving a target relay device from the relay device; and connecting with the target relay device.

According to the embodiments of the present disclosure, a subject that performs the above method may be the user equipment 1000 according to the embodiments of the present disclosure, so all the previous embodiments regarding the user equipment 1000 are applicable herein.

### 5. Application Example

The technology of the present disclosure is applicable to various products.

For example, the network side device may be implemented as any type of base station device, such as a macro eNB and a small eNB, and may be implemented as any type of gNB (a base station in a 5G system). The small eNB may be an eNB covering a cell smaller than a macro cell, such as a pico eNB, a micro eNB, or a home (femto) eNB. Alternatively, the base station may be implemented as any other type of base station, such as a NodeB and a base transceiver station (BTS). The base station may include a body (which is also referred to as a base station device) configured to control wireless communication and one or more remote radio heads (RRHs) that are arranged in a different place from the body.

The user equipment may be implemented as a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as machine type communication (MTC) terminal). In addition, the user equipment may be a wireless communication module (such as an integrated circuit module including a single wafer) installed on each of the user equipment described above.

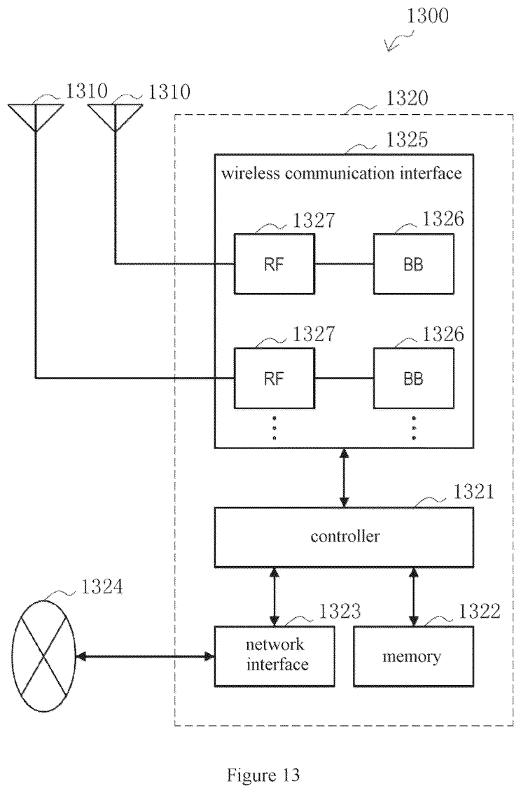

FIG. 13 is a block diagram showing a first example of a schematic configuration of an eNB to which the technology of the present disclosure may be applied. The eNB 1300 includes a single or multiple antennas 1310 and a base station device 1320. The base station device 1320 and each of the antennas 1310 may be connected with each other via an RF cable.

Each of the antennas 1310 includes a single or multiple antenna elements (such as multiple antenna elements included in a multiple-input multiple-output (MIMO) antenna), and is used for the base station device 1320 to transmit and receive wireless signals. The eNB 1300 may include multiple antennas 1310, as shown in FIG. 13. For example, the multiple antennas 1310 may be compatible with multiple frequency bands used by the eNB 1300. Although FIG. 13 shows an example in which the eNB 1300 includes multiple antennas 1310, the eNB 1300 may include a single antenna 1310.

The base station device 1320 includes a controller 1321, a memory 1322, a network interface 1323, and a wireless communication interface 1325.

The controller 1321 may be, for example, a CPU or a DSP, and operates various functions of a higher layer of the base station device 1320. For example, the controller 1321 generates a data packet based on data in a signal processed by the wireless communication interface 1325, and transfers the generated packet via the network interface 1323. The controller 1321 may bundle data from multiple baseband processors to generate a bundled packet, and transfer the generated bundled packet. The controller 1321 may have logical functions of performing control such as radio resource control, radio bearer control, mobility management, admission control, and scheduling. The control may be performed in conjunction with an adjacent eNB or a core network node. The memory 1322 includes an RAM and an ROM, and stores a program executed by the controller 1321, and various types of control data (such as a terminal list, transmission power data, and scheduling data).

The network interface 1323 is a communication interface for connecting the base station device 1320 to a core network 1324. The controller 1321 may communicate with a core network node or another eNB via the network interface 1323. In this case, the eNB 1300, and the core network node or the other eNB may be connected with each other through a logical interface (such as an S1 interface and an X2 interface). The network interface 1323 may also be a wired communication interface or a wireless communication interface for a wireless backhaul line. In a case that the network interface 1323 is a wireless communication interface, the network interface 1323 may use a higher frequency band for wireless communication than a frequency band used by the wireless communication interface 1325.

The wireless communication interface 1325 supports any cellular communication scheme (such as Long Term Evolution (LTE) and LTE-Advanced), and provides wireless connection to a terminal positioned in a cell of the eNB 1300 via the antenna 1310. The wireless communication interface 1325 may typically include, for example, a baseband (BB) processor 1326 and a RF circuit 1327. The BB processor 1326 may perform, for example, encoding/decoding, modulating/demodulating and multiplexing/de-multiplexing, and perform various types of signal processes of layers (for example, L1, media access control (MAC), radio link control (RLC) and packet data convergence protocol (PDCP)). Instead of the controller 1321, the BB processor 1326 may have a part or all of the above logical functions. The BB processor 1326 may be a memory storing a communication control program, or a module including a processor and a related circuit configured to execute the program. Updating the program may change the functions of the BB processor 1326. The module may be a card or a blade inserted into a slot of the base station device 1320. Alternatively, the module may also be a chip mounted on the card or the blade. In addition, the RF circuit 1327 may include, for example, a frequency mixer, a filter and an amplifier, and transmit and receive wireless signals via the antenna 1310.

As shown in FIG. 13, the wireless communication interface 1325 may include multiple BB processors 1326. For example, the multiple BB processors 1326 may be compatible with multiple frequency bands used by the eNB 1300. As shown in FIG. 13, the wireless communication interface 1325 may include multiple RF circuits 1327. For example, the multiple RF circuits 1327 may be compatible with multiple antenna elements. Although FIG. 13 shows an example in which the wireless communication interface 1325 includes multiple BB processors 1326 and multiple RF circuits 1327, the wireless communication interface 1325 may include a single BB processor 1326 or a single RF circuit 1327.

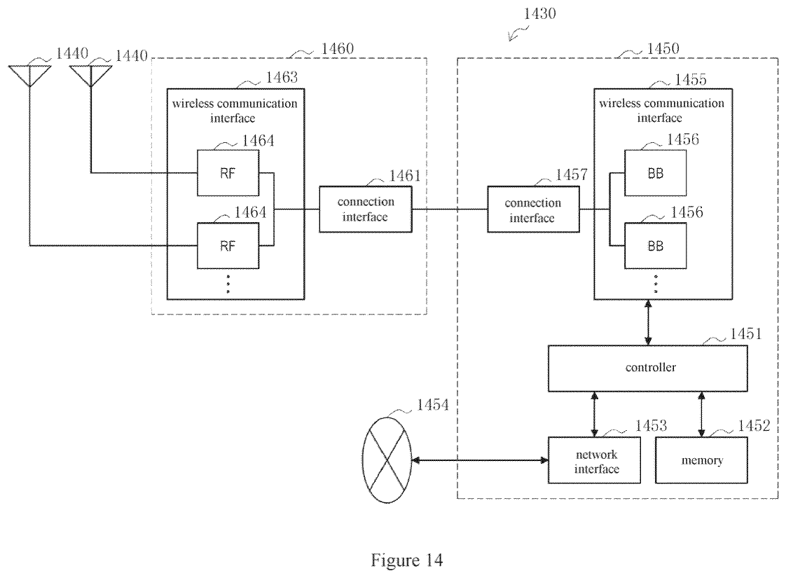

FIG. 14 is a block diagram showing a second example of a schematic configuration of an eNB to which the technology of the present disclosure may be applied. The eNB 1430 includes a single or multiple antennas 1440, a base station device 1450 and an RRH 1460. The RRH 1460 and each antenna 1440 may be connected with each other via an RF cable. The base station device 1450 and the RRH 1460 may be connected with each other via a high-speed line such as an optical fiber cable.

Each of the antennas 1440 includes a single or multiple antenna elements (such as multiple antenna elements included in an MIMO antenna), and is used for the RRH 1460 to transmit and receive wireless signals. As shown in FIG. 14, the eNB 1430 may include multiple antennas 1440. For example, the multiple antennas 1440 may be compatible with multiple frequency bands used by the eNB 1430. Although FIG. 14 shows an example in which the eNB 1430 includes multiple antennas 1440, the eNB 1430 may include a single antenna 1440.

The base station device 1450 includes a controller 1451, a memory 1452, a network interface 1453, a wireless communication interface 1455, and a connection interface 1457. The controller 1451, the memory 1452, and the network interface 1453 are the same as the controller 1321, the memory 1322, and the network interface 1323 described with reference to FIG. 13.

The wireless communication interface 1455 supports any cellular communication scheme (such as LTE and LTE-advanced), and provides wireless communication with a terminal located in a sector corresponding to the RRH 1460 via the RRH 1460 and the antenna 1440. The wireless communication interface 1455 may typically include, for example, a BB processor 1456. The BB processor 1456 is the same as the BB processor 1326 described with reference to FIG. 13, except that the BB processor 1456 is connected with a RF circuit 1464 of the RRH 1460 via the connection interface 1457. As shown in FIG. 14, the wireless communication interface 1455 may include multiple BB processors 1456. For example, the multiple BB processors 1456 may be compatible with multiple frequency bands used by the eNB 1430. Although FIG. 14 shows an example in which the wireless communication interface 1455 includes multiple BB processors 1456, the wireless communication interface 1455 may include a single BB processor 1456.

The connection interface 1457 is an interface for connecting the base station device 1450 (the wireless communication interface 1455) to the RRH 1460. The connection interface 1457 may also be a communication module for communication in the above high-speed line that connects the base station device 1450 (the wireless communication interface 1455) to the RRH 1460.

The RRH 1460 includes a connection interface 1461 and a wireless communication interface 1463.

The connection interface 1461 is an interface for connecting the RRH 1460 (the wireless communication interface 1463) to the base station device 1450. The connection interface 1461 may also be a communication module for communication in the above high-speed line.

The wireless communication interface 1463 transmits and receives wireless signals via the antenna 1440. The wireless communication interface 1463 may typically include, for example, the RF circuit 1464. The RF circuit 1464 may include, for example, a frequency mixer, a filter and an amplifier, and transmit and receive wireless signals via the antenna 1440. The wireless communication interface 1463 may include multiple RF circuits 1464, as shown in FIG. 14. For example, the multiple RF circuits 1464 may support multiple antenna elements. Although FIG. 14 shows an example in which the wireless communication interface 1463 includes multiple RF circuits 1464, the wireless communication interface 1463 may include a single RF circuit 1464.

In the eNB 1300 shown in FIG. 13 and the eNB 1430 shown in FIG. 14, the candidate relay device determination unit 310, the ranking unit 320, the prediction unit 340, the power determination unit 350, the setting unit 360, the configuration unit 370, the updating unit 380, and the determination unit 390 described in connection with FIG. 3 may be implemented by the controller 1321 and/or the controller 1451, and the communication unit 330 described in connection with FIG. 3 may be implemented by the wireless communication interface 1325 and the wireless communication interface 1455 and/or the wireless communication interface 1463. At least a part of the functions may be implemented by the controller 1321 and the controller 1451. For example, the controller 1321 and/or the controller 1451 may determine the candidate relay devices, rank the candidate relay devices, predict the energy change curve, determine the transmission power, set the user equipment as the relay device, configure the updating time period, the transmission time period, and the starting time instant of the first updating time period for the relay device, update the user equipment group and the relay device, and determine whether the user equipment can serve as a relay device, by executing instructions stored in a corresponding memory.

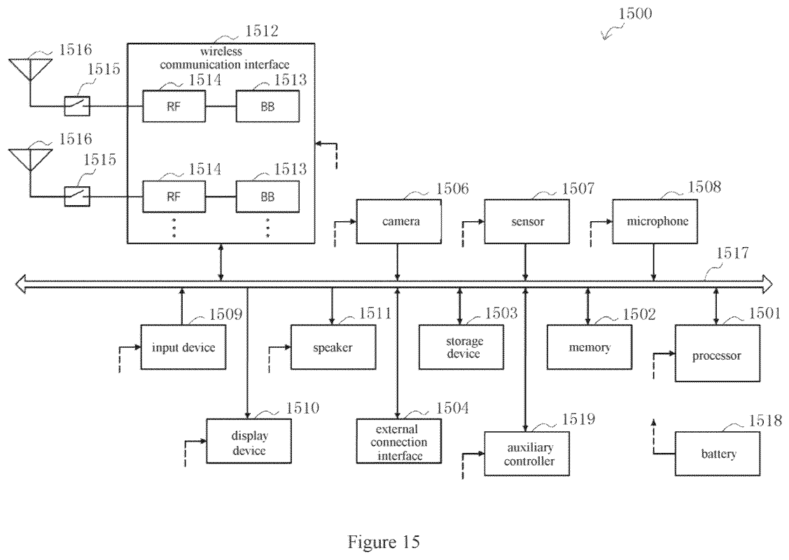

FIG. 15 is a block diagram showing an example of a schematic configuration of a smartphone 1500 to which the technology of the present disclosure may be applied. The smartphone 1500 includes a processor 1501, a memory 1502, a storage device 1503, an external connection interface 1504, a camera 1506, a sensor 1507, a microphone 1508, an input device 1509, a display device 1510, a speaker 1511, a wireless communication interface 1512, one or more antenna switches 1515, one or more antennas 1516, a bus 1517, a battery 1518 and an auxiliary controller 1519.

The processor 1501 may be, for example, a CPU or a system on chip (SoC), and control functions of an application layer and another layer of the smartphone 1500. The memory 1502 includes an RAM and an ROM, and stores a program that is executed by the processor 1501, and data. The storage device 1503 may include a storage medium such as a semiconductor memory and a hard disk. The external connection interface 1504 is an interface for connecting an external device (such as a memory card and a universal serial bus (USB) device) to the smartphone 1500.

The camera 1506 includes an image sensor (such as a charge coupled device (CCD) and a complementary metal oxide semiconductor (CMOS)) and generates a captured image. The sensor 1507 may include a group of sensors, such as a measurement sensor, a gyroscope sensor, a geomagnetic sensor and an acceleration sensor. The microphone 1508 converts sounds that are inputted to the smartphone 1500 into audio signals. The input device 1509 includes, for example, a touch sensor configured to detect touch on a screen of the display device 1510, a keypad, a keyboard, a button, or a switch, and receives an operation or information inputted from a user. The display device 1510 includes a screen (such as a liquid crystal display (LCD) and an organic light-emitting diode (OLED) display), and displays an output image of the smartphone 1500. The speaker 1511 converts audio signals that are outputted from the smartphone 1500 to sounds.

The wireless communication interface 1512 supports any cellular communication scheme (such as LTE and LTE-Advanced), and performs wireless communications. The wireless communication interface 1512 may typically include, for example, a BB processor 1513 and a RF circuit 1514. The BB processor 1513 may perform, for example, encoding/decoding, modulating/demodulating and multiplexing/de-multiplexing, and perform various types of signal processing for wireless communications. Meanwhile, the RF circuit 1514 may include, for example, a frequency mixer, a filter and an amplifier, and transmit and receive wireless signals via the antenna 1516. The wireless communication interface 1512 may be a chip module on which the BB processor 1513 and the RF circuit 1514 are integrated. As shown in FIG. 15, the wireless communication interface 1512 may include multiple BB processors 1513 and multiple RF circuits 1514. Although FIG. 15 shows an example in which the wireless communication interface 1512 includes multiple BB processors 1513 and multiple RF circuits 1514, the wireless communication interface 1512 may include a single BB processor 1513 or a single RF circuit 1514.

Furthermore, in addition to the cellular communication scheme, the wireless communication interface 1512 may support another type of wireless communication scheme such as a short-distance wireless communication scheme, a near field communication scheme, and a wireless local area network (LAN) scheme. In this case, the wireless communication interface 1512 may include a BB processor 1513 and a RF circuit 1514 for each wireless communication scheme.

Each of the antenna switches 1515 re-determines a connection destination of the antenna 1516 among multiple circuits (such as circuits for different wireless communication schemes) included in the wireless communication interface 1512.

Each of the antennas 1516 includes a single or multiple antenna elements (such as multiple antenna elements included in an MIMO antenna), and is used for the wireless communication interface 1512 to transmit and receive wireless signals. The smartphone 1500 may include multiple antennas 1516, as shown in FIG. 15. Although FIG. 15 shows an example in which the smartphone 1500 includes multiple antennas 1516, the smartphone 1500 may include a single antenna 1516.

Furthermore, the smartphone 1500 may include an antenna 1516 for each wireless communication scheme. In this case, the antenna switch 1515 may be omitted from the configuration of the smartphone 1500.

The processor 1501, the memory 1502, the storage device 1503, the external connection interface 1504, the camera 1506, the sensor 1507, the microphone 1508, the input device 1509, the display device 1510, the speaker 1511, the wireless communication interface 1512 and the auxiliary controller 1519 are connected with each other via the bus 1517. The battery 1518 supplies power to blocks in the smartphone 1500 shown in FIG. 15 via a feeder line which is indicated partially as a dashed line in FIG. 15. The auxiliary controller 1519 operates a minimum necessary function of the smartphone 1500 in a sleeping mode, for example.

In the smartphone 1500 shown in FIG. 15, the connection unit 1020, the relay device determination unit 1030, the set determination unit 1040, the information generation unit 1050, and the processing unit 1060 described in connection with FIG. 10 may be implemented by the processor 1501 or the auxiliary controller 1519, and the communication unit 1010 described in connection with FIG. 10 may be implemented by the wireless communication interface 1512. At least a part of the functions may be implemented by the processor 1501 or the auxiliary controller 1519. For example, the processor 1501 or the auxiliary controller 1519 may connect with the relay device, determine the relay device, selecting an ordered set of candidate relay devices, generate information, and periodically enter the updating time period and the transmission time period by executing instructions stored in the memory 1502 or the storage device 1503.

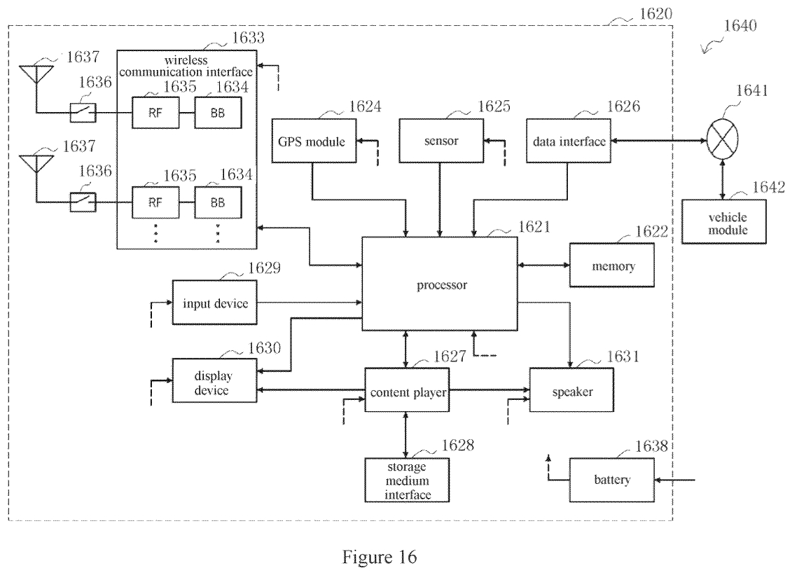

FIG. 16 is a block diagram showing an example of a schematic configuration of a car navigation device 1620 to which the technology of the present disclosure may be applied. The car navigation device 1620 includes a processor 1621, a memory 1622, a global positioning system (GPS) module 1624, a sensor 1625, a data interface 1626, a content player 1627, a storage medium interface 1628, an input device 1629, a display device 1630, a speaker 1631, a wireless communication interface 1633, one or more antenna switches 1636, one or more antennas 1637 and a battery 1638.

The processor 1621 may be, for example, a CPU or an SoC, and control a navigation function and another function of the car navigation device 1620. The memory 1622 includes an RAM and an ROM, and stores a program that is executed by the processor 1621, and data.

The GPS module 1624 measures a position (such as latitude, longitude and altitude) of the car navigation device 1620 based on a GPS signal received from a GPS satellite. The sensor 1625 may include a group of sensors such as a gyroscope sensor, a geomagnetic sensor, and an air pressure sensor. The data interface 1626 is connected with, for example, an in-vehicle network 1641 via a terminal not shown, and acquires data generated by the vehicle (such as vehicle speed data).

The content player 1627 reproduces content stored in a storage medium (such as a CD and a DVD) inserted into the storage medium interface 1628. The input device 1629 includes, for example, a touch sensor configured to detect touch on a screen of the display device 1630, a button, or a switch, and receives an operation or information inputted from a user. The display device 1630 includes a screen such as an LCD or an OLED display, and displays an image of the navigation function or content that is reproduced. The speaker 1631 outputs sound of the navigation function or the content that is reproduced.

The wireless communication interface 1633 supports any cellular communication scheme (such as LTE and LTE-Advanced), and performs wireless communications. The wireless communication interface 1633 may typically include, for example, a BB processor 1634 and a RF circuit 1635. The BB processor 1634 may perform, for example, encoding/decoding, modulating/demodulating and multiplexing/de-multiplexing, and perform various types of signal processing for wireless communications. Meanwhile, the RF circuit 1635 may include, for example, a frequency mixer, a filter and an amplifier, and transmit and receive wireless signals via the antenna 1637. The wireless communication interface 1633 may also be a chip module on which the BB processor 1634 and the RF circuit 1635 are integrated. As shown in FIG. 16, the wireless communication interface 1633 may include multiple BB processors 1634 and multiple RF circuits 1635. Although FIG. 16 shows an example in which the wireless communication interface 1633 includes multiple BB processors 1634 and multiple RF circuits 1635, the wireless communication interface 1633 may include a single BB processor 1634 or a single RF circuit 1635.

Furthermore, in addition to the cellular communication scheme, the wireless communication interface 1633 may support another type of wireless communication scheme such as a short-distance wireless communication scheme, a near field communication scheme, and a wireless LAN scheme. In this case, the wireless communication interface 1633 may include a BB processor 1634 and a RF circuit 1635 for each type of wireless communication scheme.

Each of the antenna switches 1636 re-determines a connection destination of the antenna 1637 among multiple circuits (such as circuits for different wireless communication schemes) included in the wireless communication interface 1633.

Each of the antennas 1637 includes a single or multiple antenna elements (such as multiple antenna elements included in an MIMO antenna), and is used for the wireless communication interface 1633 to transmit and receive wireless signals. The car navigation device 1620 may include multiple antennas 1637, as shown in FIG. 16. Although FIG. 16 shows an example in which the car navigation device 1620 includes multiple antennas 1637, the car navigation device 1620 may include a single antenna 1637.

In addition, the car navigation device 1620 may include an antenna 1637 for each type of wireless communication scheme. In this case, the antenna switch 1636 may be omitted from the configuration of the car navigation device 1620.

The battery 1638 supplies power to blocks in the car navigation device 1620 shown in FIG. 16 via a feeder line which is indicated partially as a dashed line in FIG. 16. The battery 1638 accumulates power supplied from the vehicle.

In the car navigation device 1620 shown in FIG. 16, the connection unit 1020, the relay device determination unit 1030, the set determination unit 1040, the information generation unit 1050, and the processing unit 1060 described in connection with FIG. 10 may be implemented by the processor 1621, and the communication unit 1010 described in connection with FIG. 10 may be implemented by the wireless communication interface 1633. At least a part of the functions may be implemented by the processor 1621. For example, the processor 1621 may connect with the relay device, determine the relay device, selecting an ordered set of candidate relay devices, generate information, and periodically enter the updating time period and the transmission time period by executing instructions stored in the memory 1622.

The technology of the present disclosure may also be implemented as an in-vehicle system (or a vehicle) 1640 including one or more blocks of the car navigation device 1620, the in-vehicle network 1641 and a vehicle module 1642. The vehicle module 1642 generates vehicle data (such as vehicle speed, engine speed, and fault information), and outputs the generated data to the in-vehicle network 1641.

Preferred embodiments of the present disclosure have been described above with reference to the drawings. However, the present disclosure is not limited to the above examples. Those skilled in the art may make various changes and modifications within the scope of the appended claims, and it should be understood that such changes and modifications naturally fall within the technical scope of the present disclosure.

For example, a unit shown by a dotted line box in the functional block diagram in the drawings indicates that the functional unit is optional in the corresponding device, and the optional functional units may be combined appropriately to achieve desired functions.

For example, multiple functions implemented by one unit in the above embodiments may be implemented by separate devices. Alternatively, multiple functions implemented by respective units in the above embodiments may be implemented by separate devices, respectively. In addition, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in another sequence appropriately.

Embodiments of the present disclosure are described above in detail in conjunction with the drawings. However, it should be understood that the embodiments described above are intended to illustrate the present disclosure rather than limit the present disclosure. Those skilled in the art may make various modifications and alternations to the above embodiments without departing from the spirit and scope of the present disclosure. Therefore, the scope of the present disclosure is defined by the appended claims and equivalents thereof.

1. An electronic device, comprising:
at least one processor; and
at least one memory including computer program code, where the at least one memory and the computer program code are configured, with the at least one processor, to cause the electronic device to:
determine one or more candidate relay devices for user equipment;
rank the one or more candidate relay devices based on energy harvesting capabilities of the one or more candidate relay devices to generate an ordered set of candidate relay devices; and
send the ordered set of candidate relay devices to the user equipment, for the user equipment to determine a relay device based on the ordered set of candidate relay devices and to communicate with a satellite device using the relay device,
wherein the candidate relay device converts harvested energy into electrical energy to supply power to the candidate relay device.

2. The electronic device according to claim 1, wherein the at least one memory and the computer program code are further configured, with the at least one processor, to cause the electronic device to:
predict an energy change curve reflecting a change of energy of the user equipment over time within a predetermined time period in the future;
determine a transmission power of the user equipment based on the energy change curve; and
determine the one or more candidate relay devices for the user equipment based on the transmission power of the user equipment, and
wherein the user equipment converts harvested energy into electrical energy to supply power to the user equipment.

3. The electronic device according to claim 2, wherein the at least one memory and the computer program code are further configured, with the at least one processor, to cause the electronic device to:
determine, for each transmission power of one or more transmission powers of the user equipment, one or more candidate relay devices for the transmission power.

4. The electronic device according to claim 2, wherein the at least one memory and the computer program code are further configured, with the at least one processor, to cause the electronic device to:
predict the energy change curve based on current energy, a change in energy harvesting capability, and a change in energy consumption capability of the user equipment.

5. The electronic device according to claim 4, wherein the at least one memory and the computer program code are further configured, with the at least one processor, to cause the electronic device to determine the change in the energy harvesting capability of the user equipment based on one or more of the following parameters: a position of the user equipment, an energy source of the user equipment, weather conditions associated with the energy source of the user equipment, an antenna parameter of the user equipment, and energy harvesting capability of the user equipment; and/or
the at least one memory and the computer program code are further configured, with the at least one processor, to cause the electronic device to determine the change in the energy consumption capability of the user equipment based on one or more of the following parameters: sizes of data packets of the user equipment, a transmission rate of the data packets of the user equipment, a time interval between data packets of the user equipment, and requirements of the user equipment for a transmission delay.

6. The electronic device according to claim 2, wherein the at least one memory and the computer program code are further configured, with the at least one processor, to cause the electronic device to:
determine the transmission power of the user equipment based on the energy change curve of the user equipment and a mapping relationship between the energy and the transmission power of the user equipment.

7. The electronic device according to claim 2, wherein the at least one memory and the computer program code are further configured, with the at least one processor, to cause the electronic device to:
determine a relay device capable of receiving information sent by the user equipment based on the transmission power of the user equipment, and
determine the relay device capable of receiving the information sent by the user equipment as the candidate relay device for the user equipment; and
determine, in a case that there is no relay device capable of receiving the information sent by the user equipment, the user equipment as the relay device.

8. (canceled)

9. The electronic device according to claim 1, wherein the at least one memory and the computer program code are further configured, with the at least one processor, to cause the electronic device to:
rank the one or more candidate relay devices further based on one or more of the following parameters of the one or more candidate relay devices: a distance between the candidate relay device and the user equipment, weather conditions associated with an energy source of the candidate relay device, a buffer size of the candidate relay device, the number of user equipment served by the candidate relay device, and quality of connection between the candidate relay device and the satellite device.

10. The electronic device according to claim 7, wherein the at least one memory and the computer program code are further configured, with the at least one processor, to cause the electronic device to:
set, for each relay device, an updating time period, a transmission time period, and a starting time instant of a first updating time period to enable the relay device to periodically enter the updating time period and the transmission time period, wherein during the updating time period, the relay device establishes a connection with a core network through the satellite device, and during the transmission time period, the relay device communicates with the user equipment or the relay device communicates with the satellite device.

11. The electronic device according to claim 10, wherein the at least one memory and the computer program code are further configured, with the at least one processor, to cause the electronic device to:
determine a length of the updating time period based on the number of user equipment served by the relay device; and/or
determine a length of the transmission time period based on an energy consumption capability of the relay device and an ephemeris of each satellite device.

12. The electronic device according to claim 10, wherein the at least one memory and the computer program code are further configured, with the at least one processor, to cause the electronic device to:
send a starting time instant of a next updating time period of each candidate relay device to the user equipment.

13. The electronic device according to claim 10, wherein the at least one memory and the computer program code are further configured, with the at least one processor, to cause the electronic device to:
establish, during the updating time period of each relay device, a connection with the relay device;
receive, from the relay device, current energy of the relay device, an energy harvesting capability of the relay device, current energy of each user equipment served by the relay device, and an energy harvesting capability of each user equipment served by the relay device;
dividing the user equipment served by the relay device into user equipment groups based on the information received from the relay device, and determine a target relay device for each of the user equipment groups; and
send a result of dividing the user equipment into user equipment groups and the target relay device for each of the user equipment groups to the relay device.

14. The electronic device according to claim 13, wherein the at least one memory and the computer program code are further configured, with the at least one processor, to cause the electronic device to:
determine the target relay device from among the relay device and the user equipment that is served by the relay device and meets a condition of the relay device, and
wherein, it is determined that the user equipment meets the condition of the relay device in a case that the user equipment meets one or more of the following conditions:
quality of connection between the user equipment and the satellite device is greater than a first predetermined threshold;
quality of connection between the user equipment and a predetermined number of other user equipment is greater than a second predetermined threshold;
a buffer size of the user equipment is greater than a third predetermined threshold; and
remaining energy of the user equipment during a time period in the future is greater than a fourth predetermined threshold; or
determine the target relay device from among user equipment not belonging to the user equipment served by the relay device.

15. (canceled)

16. User equipment, comprising:
at least one processor; and
at least one memory including computer program code, where the at least one memory and the computer program code are configured, with the at least one processor, to cause the user equipment to:
receive an ordered set of candidate relay devices from a network side device, wherein the ordered set of candidate relay devices is generated by ranking one or more candidate relay devices based on energy harvesting capabilities of the one or more candidate relay devices;
sequentially perform connection with candidate relay devices in the ordered set of candidate relay devices according to an order in the ordered set of candidate relay devices until successful connection with a candidate relay device, and determine the candidate relay device in successful connection as a relay device; and
communicate with a satellite device using the relay device,
wherein the candidate relay device converts harvested energy into electrical energy to supply power to the candidate relay device.

17. The user equipment according to claim 16, wherein the at least one memory and the computer program code are further configured, with the at least one processor, to cause the user equipment to:
receive the ordered set of the one or more candidate relay devices from the network side device, wherein each ordered set of candidate relay devices corresponds to one transmission power of the user equipment; and
determine, based on an actual transmission power of the user equipment, an ordered set of candidate relay devices corresponding to the actual transmission power.

18. The user equipment according to claim 16, wherein the at least one memory and the computer program code are further configured, with the at least one processor, to cause the user equipment to:
send, to the network side device, one or more of the following parameters: a position of the user equipment, current energy of the user equipment, an energy source of the user equipment, a mapping relationship between energy and transmission power of the user equipment, an antenna parameter of the user equipment, an energy harvesting capability of the user equipment, sizes of data packets of the user equipment, a transmission rate of the data packets of the user equipment, a time interval between the data packets of the user equipment, and requirements of the user equipment for a transmission delay.

19. The user equipment according to claim 16, wherein the at least one memory and the computer program code are further configured, with the at least one processor, to cause the user equipment to:
receive, from the network side device, a starting time instant of a next updating time period of each candidate relay device; and
sequentially perform connection with candidate relay devices in the ordered set of candidate relay devices at the starting time instant of the next updating time period of the candidate relay device according to an order in the ordered set of candidate relay devices until successful connection with a candidate relay device, and
wherein, each candidate relay device periodically enters the updating time period and the transmission time period, and wherein during the updating time period, the candidate relay device establishes a connection with a core network through a satellite device, and during the transmission time period, the candidate relay device communicates with the user equipment or the candidate relay device communicates with a satellite device.

20. The user equipment according to claim 16, wherein the at least one memory and the computer program code are further configured, with the at least one processor, to cause the user equipment to:
receive, from the network side device, information indicating that the user equipment serves as a relay device;
receive, from the network side device, an updating time period, a transmission time period, and a starting time instant of the first updating time period of the user equipment; and
periodically enter the updating time period and transmission time period, wherein during the updating time period, the user equipment establishes a connection with a core network through a satellite device, and during the transmission time period, the user equipment communicates with other user equipment served by the user equipment or the user equipment communicates with a satellite device.

21. The user equipment according to claim 16, wherein the at least one memory and the computer program code are further configured, with the at least one processor, to cause the user equipment to:
receive an energy reporting notification from the relay device;
send current energy and an energy harvesting capability of the user equipment to the relay device;
receive a target relay device from the relay device; and
connect with the target relay device.

22. (canceled)

23. A wireless communication method performed by an electronic device, comprising:
determining one or more candidate relay devices for user equipment;
ranking the one or more candidate relay devices based on energy harvesting capabilities of the one or more candidate relay devices to generate an ordered set of candidate relay devices; and
sending the ordered set of candidate relay devices to the user equipment, for the user equipment to determine a relay device according to the ordered set of candidate relay devices and to communicate with a satellite device using the relay device,
wherein the candidate relay device converts harvested energy into electrical energy to supply power to the candidate relay device.

24.-45. (canceled)
